(19) United States
(12) Patent Application Publication
(10) Pub. No.: US 2008/0201935 A1
(43) Pub. Date: Aug. 28, 2008

(54) Manufacturing Method for Rotary Electric Machine and Stator

(75) Inventors: Kenichi NAKAYAMA, Hitachinaka (JP); Takashi Ishigami, Hitachinaka (JP); Akira Toba, Naka (JP); Tomohiro Adachi, Hitachi (JP); Tsuyoshi Goto, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/036,571

(22) Filed: Feb. 25, 2008

(30) Foreign Application Priority Data
Feb. 26, 2007 (JP) 2007-044840

(51) Int. Cl. H02K 15/02; H02K 15/085

(52) U.S. Cl. 29/596; 29/598

(57) ABSTRACT

A manufacturing method for a rotary electric machine according to the present invention comprises steps of: (1) preforming a coil including a plurality of element coils of an insulated conductor; (2) inserting a first side of a first element coil of the element coils into a first slot of a stator core through an opening of the first slot; (3) inserting a second side of the first element coil into a second slot in which a first side of a second element coil of the element coil has been already inserted; (4) electrically connecting coil ends of a plurality of the coils to each other; and (5) rotatably mounting a rotor inside the stator core.

### CLAIM OF PRIORITY

The present application claims priority from Japanese application serial no. 2007-044840 filed on Feb. 26, 2007, the content of which is hereby incorporated by reference into this application.

### BACKGROUND OF THE INVENTION

1. Field of the Invention

The present invention relates to manufacturing methods for rotary electric machines such as motors and generators, and stators used therein.

2. Description of Related Art

A stator winding of a rotary electric machine is retained, often using a distributed winding, in a number of stator core slots each having an opening at the inner periphery of the core. An AC supply to the stator winding of a rotary electric machine causes a rotating magnetic field within the stator, which in turn generates a rotational torque on a rotor. Such a rotary electric machine includes an induction electric motor using a squirrel cage rotor and a synchronous electric motor using a permanent magnet rotor. Such induction and synchronous electric motors can also operate as a generator. Hereinafter, such electric motors and generators are collectively referred to as rotary electric machines.

JP-A-2006-211810 discloses a rotary electric machine, stator windings of which are formed by connecting segmented conductors to each other. The rotary electric machine has a stator core including a number of slots each having an opening at the inner periphery of the core, and substantially U-shaped segment conductors are inserted in the slots. The above JP-A-2006-211810 describes that the method thereof can reduce the size and weight of a rotary electric machine.

In a rotary electric machine such as described in JP-A-2006-211810, the stator windings are formed by inserting substantially U-shaped segment conductors in slots and connecting them to each other; therefore there are productivity disadvantages which should be improved in that, e.g., the ends of the segment conductors need to be connected to each other by welding, thus incurring increase in the number of welding operations.

### SUMMARY OF THE INVENTION

Under these circumstances, the present invention is originated to solve the above problems. It is an object of the present invention is to provide a manufacturing method of a rotary electric machine having excellent productivity.

A feature of the present invention is a manufacturing method for a stator of a rotary electric machine having a stator winding including steps of: preforming a stator coil including a plurality of element coils; disposing the plurality of element coils along an inner periphery of the stator such that one side of each element coil is inserted in the bottom side of a stator slot and the other side thereof is inserted in the opening side of another stator slot; and electrically connecting a plurality of the stator coils to each other.

Manufacturing methods according to below-described embodiments of the present invention have various features and advantages other than the above feature. Such features and advantages will be described with reference to the following embodiments.

### Advantages of the Invention

The present invention can provide a manufacturing method of a rotary electric machine or a stator. Use of the manufacturing methods for a rotary electric machine or a stator according to the present invention can enhance the productivity thereof.

### BRIEF DESCRIPTION OF THE DRAWINGS

FIG. 1 is a schematic illustration showing a side cross-sectional view of an example of an induction rotary electric machine.

FIG. 2 is a schematic illustration showing a perspective cross-sectional view of a rotor.

FIG. 3 is a schematic illustration showing an exploded perspective view of an induction rotary electric machine according to an embodiment of the present invention.

FIG. 4 is a system diagram of an example of an electrical connection used in a rotary electric machine.

FIG. 5 is a schematic illustration showing a rotating magnetic field generated by stator windings.

FIG. 6 is a simulation result illustrating magnetic field lines when a rotor rotates slower than a rotating magnetic field generated within a stator core.

FIG. 7 is a schematic illustration showing a perspective view of a stator.

FIG. 8 is a schematic illustration showing a perspective view of a stator coil comprising stator windings formed of a single continuous insulated conductor.

FIG. 9 is a schematic illustration showing a perspective view of stator coils of one phase.

FIG. 10 is a schematic illustration showing a front view of a stator viewed in the axial direction.

FIG. 11 is a schematic illustration showing a side view of a stator.

FIG. 12 is an overall interconnection diagram of 2Y-connected stator windings shown in FIG. 4.

FIG. 13 shows a relationship between stator slot number and element coil of stator windings.

FIG. 14 is a flow chart for explaining an example of manufacturing steps according to a first embodiment of the present invention.

FIGS. 15(a) and 15(b) are schematic illustrations for explaining a method for forming oval shaped element coils, according to a first embodiment.

FIG. 16 is a schematic illustration showing a perspective view in which oval shaped element coils are then being pressed according to a first embodiment.

FIG. 17 is a schematic illustration showing a perspective view of a stator coil preformed according to a first embodiment.

FIG. 18(A) is a schematic illustration showing a side view in which a preformed stator coil is further deformed according to a first embodiment.

FIG. 18(B) is another schematic illustration showing a side view in which a preformed stator coil is further deformed according to a first embodiment.

FIG. 19 is a schematic illustration showing a perspective view in which a stator coil preformed according to a first embodiment is inserted in slots of a stator core.

FIG. 20 is a schematic illustration showing a perspective view in which pushing members of an inner jig used in a first embodiment are retracted.

FIG. 21 is a schematic illustration showing a perspective view in which pushing members of an inner jig used in a first embodiment are projected.

FIG. 22 is a schematic illustration showing a perspective cross-sectional view of a stator core in which tooth support jigs are inserted in each slot, with the upper part thereof removed.

FIGS. 23(a) and 23(b) are schematic illustrations showing a perspective view in which preformed stator coils are inserted in slots of a stator core, thereafter an inner jig is inserted in a bore of the stator core, and support jigs are then fitted between adjacent preformed stator coils, according to a first embodiment.

FIG. 24 is a schematic illustration showing a perspective partial cross-sectional view in which a press jig is fitted to a stator core, according to a first embodiment.

FIG. 25 is a schematic illustration showing a perspective view of stator windings preliminary formed according to a first embodiment.

FIG. 26 is a schematic illustration for explaining how an element coil is deformed during an insertion step of a first embodiment.

FIG. 27 is a schematic illustration showing a perspective view in which stator coils are inserted in slots of a stator core, according to a first embodiment.

FIG. 28 is a schematic illustration showing an enlarged perspective view of a coil end of a stator manufactured according to a first embodiment.

FIG. 29 is a schematic illustration showing a front cross-sectional view of a stator manufactured according to a first embodiment.

FIG. 30 is a simplified schematic illustration for explaining a manner in which a pair of element coils is wound according to a second embodiment.

FIGS. 31(a) and 31(b) are schematic illustrations for explaining a preforming method of a stator coil, according to a second embodiment.

FIG. 32 is a schematic illustration showing a perspective view of a stator coil formed by using a preforming method of a second embodiment.

FIG. 33 is a manufacturing flow chart for explaining a positioning step through an insertion step, which is a feature of a third embodiment.

FIG. 34 is a schematic illustration showing a perspective view of a preformed coil fitted in a slide jig used in a third embodiment.

FIG. 35 is a schematic illustration showing a perspective view in which a slide jig used in a third embodiment is slid to form element coils in a substantially hexagonal shape.

FIG. 36 is a schematic illustration showing an enlarged perspective view of some of holding grooves of a slide jig used in a third embodiment.

FIG. 37 is a schematic illustration showing an enlarged perspective view in which the holding grooves of one of two slide members of the slide jig in FIG. 36 are inclined.

FIG. 38 is a schematic illustration showing a perspective view in which a set of stator coils each including substantially hexagonal shaped element coils is wound around an inner jig, according to a third embodiment.

FIG. 39 is a schematic illustration showing a perspective view in which an inner jig fitted with a set of stator coils is being inserted into the bore of a stator core, according to a third embodiment.

FIGS. 40(a) to 40(c) are schematic illustrations showing perspective views in which an insertion step is carried out according to a third embodiment.

FIG. 41 is a schematic illustration showing a perspective view in which an inner jig is being removed according to a third embodiment.

FIG. 42 is a schematic illustration showing a perspective view in which neighboring pairs of element coils are connected to each other via a crossover wire, according to a fourth embodiment.

FIG. 43 is a schematic illustration showing a perspective view of a stator manufactured according to a fifth embodiment.

FIG. 44 is a schematic illustration showing a perspective view of a stator manufactured according to a sixth embodiment.

FIG. 45 is a schematic illustration showing a cross sectional view of a permanent magnet rotary electric machine.

FIG. 46 is a schematic illustration showing a cross sectional view of a stator and a rotor cutting along A-A line in FIG. 45.

### DETAILED DESCRIPTION OF THE PREFERRED EMBODIMENTS

(Configuration of Rotary Electric Machine)

Before describing methods for manufacturing a rotary electric machine or a stator therein according to the present invention, a configuration of a rotary electric machine related to the invention will be firstly described.

The rotary electric machine described in the following embodiments is used for an electric motor for driving a vehicle and can provide a relatively large output even with a small size. It also has a distinctive structure leading to productivity improvement. Such a motor for driving a vehicle includes: an electric motor for starting an engine; an electric motor for generating a torque for driving a vehicle in cooperation with an engine; and an electric motor for driving a vehicle by itself.

An electric motor for use in a hybrid vehicle will be described as an example of a rotary electric machine according to the present invention. The electric motor for hybrid vehicle use according to this embodiment has functions both as a motor for driving the vehicle wheels and as a power generator, and switches between the two functions depending on the running conditions of the vehicle.

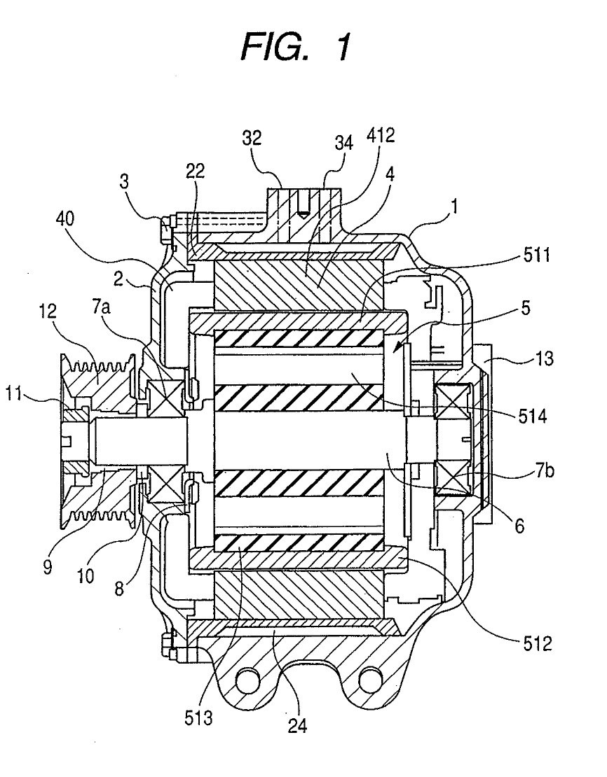

A rotary electric machine for a hybrid vehicle according to an embodiment of the present invention will be explained with reference to the attached drawings. FIG. 1 is a schematic illustration showing a side cross-sectional view of an example of an induction rotary electric machine.

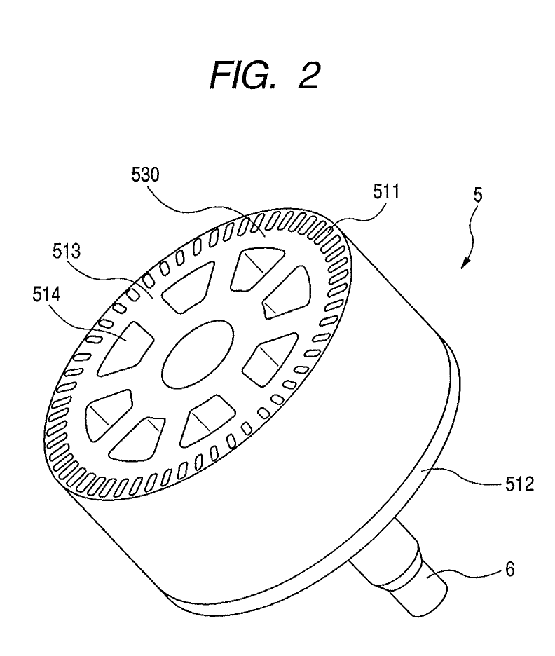

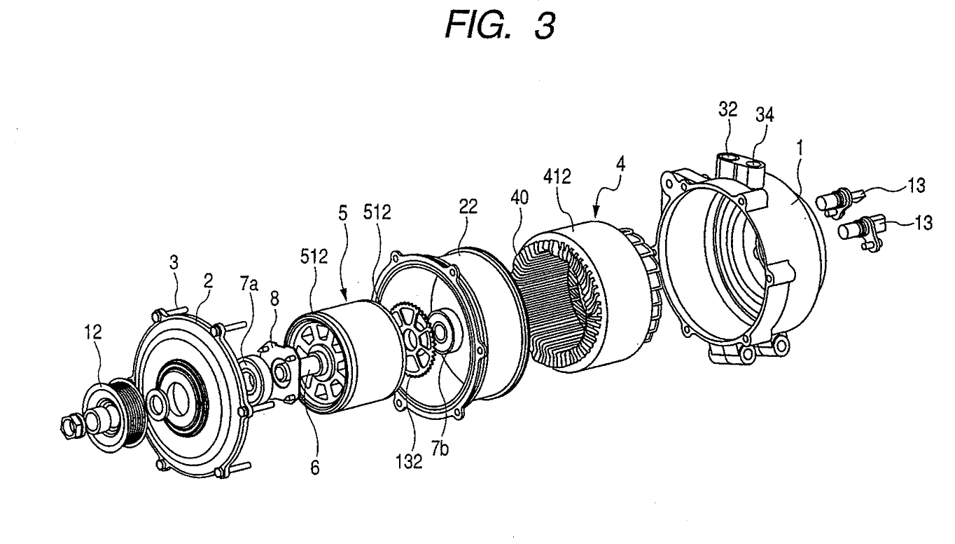

FIG. 2 is a schematic illustration showing a perspective cross-sectional view of a rotor. FIG. 3 is a schematic illustration showing an exploded perspective view of the induction rotary electric machine according to the embodiment.

As shown in FIGS. 1 and 3, the induction rotary electric machine has a cylindrical housing 1 having a closed end and a cover 2 for sealing an open end of the housing 1. Along an inner periphery of the housing 1 is provided a water channel forming member 22, one end of which is fixed between the housing 1 and cover 2, thereby forming a water channel 24 between a stator 4 and the housing 1. Cooling water for cooling the rotary electric machine is fed into the water channel 24 through a cooling water inlet 32 and is exhausted through an exhaust outlet 34. The housing 1 and cover 2 are bolted together by multiple (e.g., six) bolts 3.

Along the inner periphery of the housing 1 is provided the water channel forming member 22, and the stator 4 is surrounded by and fixed to the member 22 by, for example, shrinkage fitting. The stator 4 includes: a stator core 412 having circumferentially equally spaced multiple slots 411; and three-phase stator windings 40 wound around the stator core 412 through the slots 411, as shown in FIG. 6 (described later in detail). This embodiment has 8 poles and 48 slots, in which the stator windings 40 are star connected. Each winding phase includes a pair of parallel connected stator coils 413, thus providing a 2Y connection (which will be detailed later).

A rotor 5 is rotatably mounted within the stator core 412 with minimal gap therebetween. The rotor 5 is fixed to rotates together with a shaft 6. The shaft 6 is rotatably supported, at both ends thereof, by ball bearings 7a and 7b respectively provided at the housing 1 and cover 2. The ball bearing 7a is fastened to the cover 2 by a substantially square clamping plate 8 shown in FIG. 3, while the ball bearing 7b is fixed in a concavity portion provided in the closed end of the housing 1. This allows the rotor 4 to revolve relative to the stator 4, and the rotation of the shaft 6 is outputted via a pulley 12 which is secured, by a nut 11, to an end of the shaft 6 on the side of an outer face of the cover 2 by means of a sleeve 9 and a spacer 10. Or, conversely, the rotation of the pulley 12 is inputted to the shaft 6. Besides, the outer surface of the sleeve 9 (and the inner surface of the pulley 12) is conically tapered; therefore the pulley 12 and shaft 6 can be firmly secured together by the tightening force of the nut 11, thereby allowing them to revolve together.

As shown in FIG. 2, the rotor 5 has therein circumferentially equally spaced conductor bars 511 each extending in parallel to the rotation axis thereof, and has a pair of short-circuiting rings 512 for short-circuiting the conductor bars 511 respectively provided on both axial end faces thereof, thereby configuring a squirrel cage rotor. The conductor bars 511 are embedded in a rotor core 513 made of a magnetic material. Here, FIG. 2 shows a cross-sectional view perpendicular to the rotor rotation axis for clearly illustrating the relationship between the rotor core 513 and conductor bars 511, and does not show the short-circuiting ring 512 or shaft 6 on the side of the pulley 12.

The rotor core 513 is formed by punching or etching a magnetic steel sheet of a thickness of 0.05-1 mm into multiple plates of a desired shape and by laminating them.

As shown in FIGS. 2 and 3, the rotor core 513 has therein substantially sector-shaped cavities 514 for reducing weight. The rotor core 513 also has, at the outer periphery thereof, multiple circumferentially spaced spaces each extending in parallel to the rotation axis thereof and for accommodating the conductor bars 511. The rotor core 513 has, on the side of the stator, the conductor bars 511, inside which is further provided a rotor yoke 530 for forming a magnetic circuit therein.

The stator of this embodiment has 8-pole stator windings, and therefore the radial thickness of the magnetic circuit formed in the rotor yoke 530 can be reduced compared to induction electric motors having 2 or 4 poles. Increasing the number of poles to more than 8 can further thin the thickness, but a further increase in the number to 12 or more has a problem of reduced output power and reduced efficiency. Therefore, rotary electric machines for driving a vehicle as well as those for starting a vehicle engine preferably have 6 to 10 poles, more preferably 8 or 10 poles.

The conductor bars 511 and short-circuiting rings 512 of the rotor 5 are made of aluminum, and are formed integrally with the rotor core 513 by die casting. The short-circuiting rings 512 are so formed to project out from both end faces of the rotor core 513 in the axial direction (see FIG. 3).

At the closed end of the housing 1 is provided an output rotor 132, and a rotation sensor 13 detects the teeth of the output rotor 132 and outputs an electrical signal indicating the position and rotation rate of the rotor 5. A resolver may be used as the rotation sensor 13.

Next, the operation of the induction electric machine according this embodiment will be described with reference to FIGS. 1 to 6.

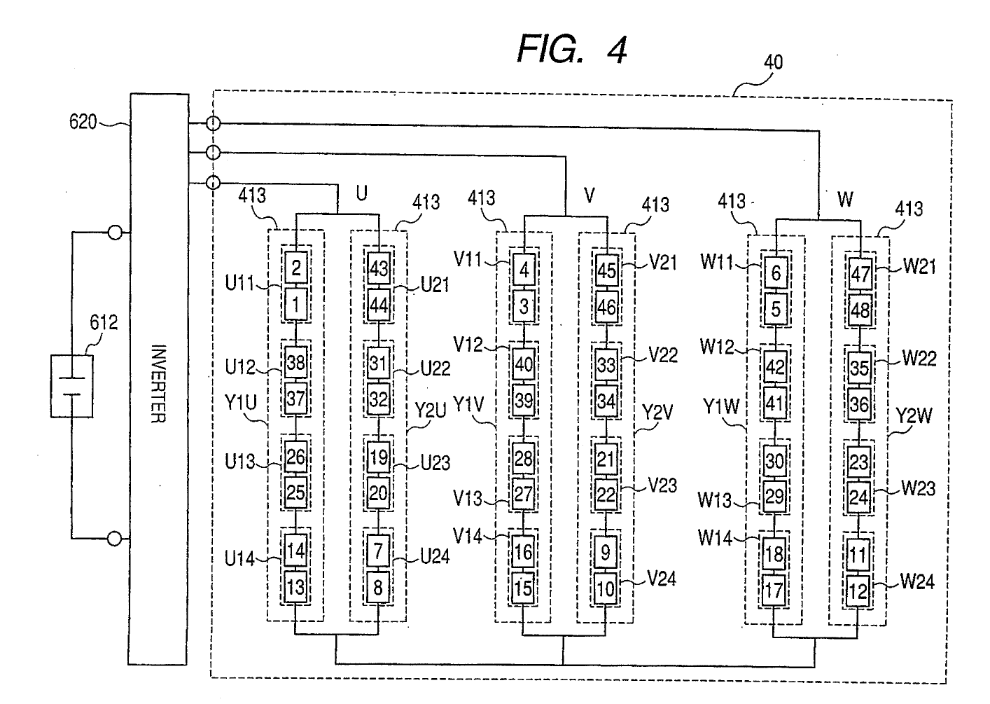

At first, a power operation of a rotary electric machine functioning as a motor for driving a vehicle wheel or a vehicle engine will be described. FIG. 4 is a system diagram of an example of an electrical connection used in a rotary electric machine, in which a 100-600 V high voltage secondary rechargeable battery 612 is connected to the DC terminals of an inverter 620. The AC terminals of the inverter 620 are electrically connected to stator windings 40. As will be described later, each phase of the stator windings 40 has a pair of parallel-connected stator coils 413. In this embodiment, each stator coil 413 is composed of four sub-coils, and each sub-coil is composed of a pair of element coils.

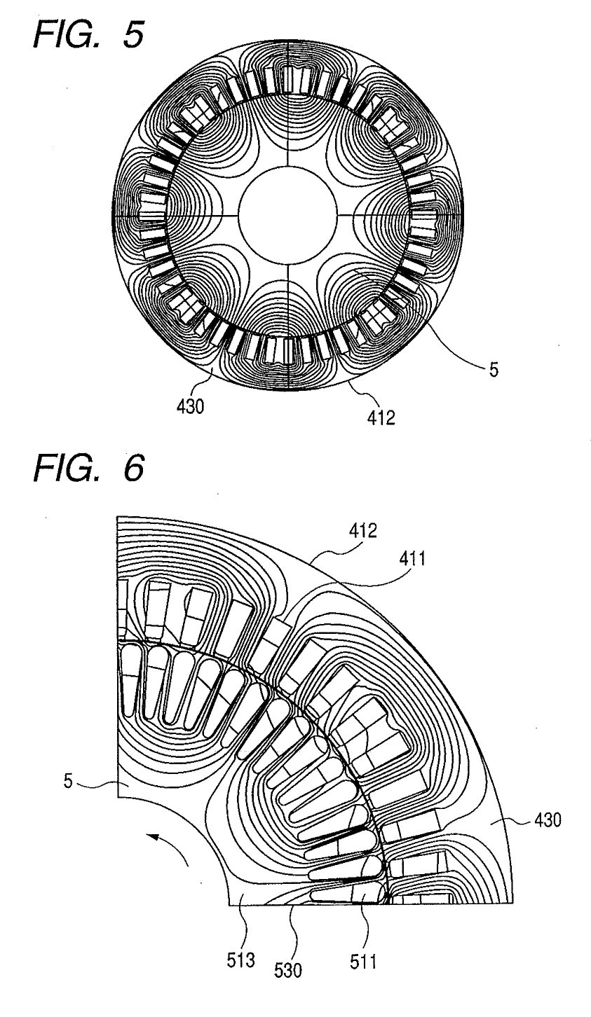

In power operation, a DC power is supplied from the secondary rechargeable battery 612 to the inverter 620, which in turn supplies an AC power to the stator coils 413 of the three-phase stator windings 40 wound around the stator core 412. This AC power generates, in the stator core 412, a rotating magnetic field having a rotation rate corresponding to the AC frequency. As shown in FIG. 5, the rotating magnetic field generates magnetic fluxes passing through the rotor 5. FIG. 5 is a schematic illustration showing a rotating magnetic field generated by the stator windings 40. The stator winding 40 is an 8-pole distributed winding as will be explained below. FIG. 5 shows a simulation result for a virtual stator core without any conductor bars in which the influence of a rotor is excluded. Along the outer periphery of the stator core 412 is provided a core back 430, which provides a magnetic circuit for the rotating magnetic field. In this simulation, the stator windings 40 have as many as 8 poles, and therefore the core back 430 for the magnetic circuit can be radially thinned. Further, the radial thickness of a magnetic circuit in the rotor 5 can also be reduced. The rotating magnetic field in FIG. 5 revolves as a function of the AC frequency supplied to the stator windings 40.

The inverter in FIG. 4 outputs an AC current required for generating a torque for driving a rotary electric machine and supplies it to the stator windings 40. When the rotor 5 rotates slower than the rotating magnetic field, the conductor bars 511 interlink the rotating magnetic field generated by the stator core 412, thereby causing a current flow in the conductor bars 511 according to Fleming's right-hand rule. The current flow in the conductor bars 511 in turn creates a rotational torque on the rotor 5 according to Fleming's left-hand rule, resulting in a rotation of the rotor 5. The difference between the rotation rates of the rotor 5 and the rotating magnetic field produced by the stator 4 affects the magnitude of the torque; therefore the rotation rate difference (i.e., slip speed) needs to be properly controlled. For this purpose, the switching frequency of the inverter (and therefore the AC frequency supplied to the stator 4) is controlled according to the rotation rate of the rotor 5 detected by the rotation sensor 13.

FIG. 6 is a simulation result illustrating magnetic field lines when the rotor 5 having the conductor bars 511 rotates slower than a rotating magnetic field generated within the stator core 412. In FIG. 6, the rotor 5 rotates counterclockwise. A magnetic flux generated by the stator windings 40 wound through the slots 411 flows through a magnetic circuit including the core back 430 and rotor yoke 530. The magnetic flux generated within the rotor core 513 lags behind the rotational movement of the magnetic flux generated within the stator core 412. The stator windings have as many as 8 poles; therefore, the magnetic field within the rotor yoke 530 on the side of conductor bars 511 is denser than that on the side of rotation axis.

Next, the operation of a rotary electric machine functioning as a generator will be described. When operated as a power generator, a rotation rate of the rotor 5 driven by a rotational force of the pulley 12 is faster than that of the rotating magnetic field generated within the stator core 412. When a rotation rate of the rotor 5 outpaces that of the rotating magnetic field, the conductor bars 511 interlink the rotating magnetic field, thereby generating a braking force on the rotor 5. This induces an electrical power to the stator windings 40, thus enabling power generation. When a rotation rate of the rotating magnetic field generated within the stator core 412 is made slower than that of the rotor 5 by reducing the AC frequency outputted from the inverter 620, in FIG. 4, a DC power is supplied from the inverter 620 to the secondary rechargeable battery 612. Power generated by a rotary electric machine depends on the difference between the rotation rates of the rotating magnetic field and the rotor 5; therefore, power generation can be controlled by controlling the operation of the inverter.

If ignoring factors such as the loss and reactive power of the rotary electric machine; when the rotating magnetic field of the rotary electric machine rotates faster than the rotor 5, a power is supplied from the secondary rechargeable battery 612 through the inverter 620 to the rotary electric machine, allowing the rotary electric machine to function as a motor; when the rotating magnetic field rotates at the same rate as the rotor 5, there is no transfer of power between the battery 612 and rotary electric machine; and when the rotating magnetic field rotates slower than the rotor 5, a power is supplied from the rotary electric machine through the inverter 620 to the battery 612. However, the factors such as the loss and reactive power of an actual rotary electric machine cannot be ignored; so, the power supply from the battery 612 to the rotary electric machine ceases at a point when the rotating field rotates somewhat slower than the rotor 5.

Next, the stator 4 will be detailed with reference to FIGS. 4 and 7 to 13.

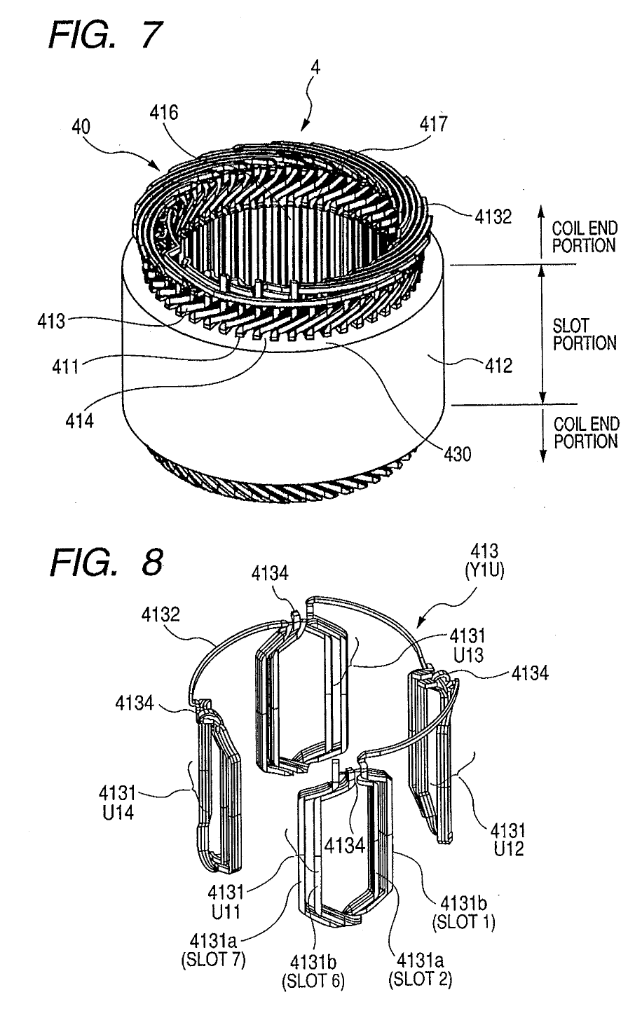

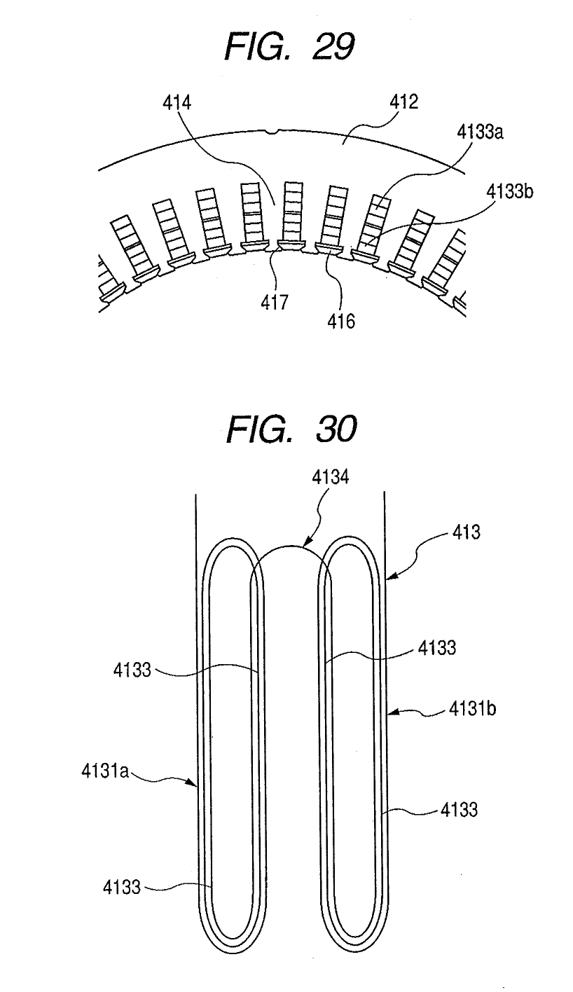

FIG. 7 is a schematic illustration showing a perspective view of the stator 4. The stator 4 in FIG. 7 has: the stator core 412 with 48 circumferentially equally spaced slots 411 formed therein; and the multiple stator coils 413 of the stator windings 40 wound around the stator core 412 through the slots 411. The stator core 412 is formed, for example, by punching or etching a magnetic steel sheet of a thickness of 0.05-1 mm into multiple plates of a desired shape and by laminating them into a laminated steel plate, in which the circumferentially equally spaced slots 411 are then formed. This embodiment has 48 slots. Between adjacent slots 411 are provided teeth 414 which are integrated with the cylindrical core back 430. That is, the teeth 414 and core back 430 are integrally formed. Further, the slots 411 have, on their inner periphery side, an opening, into which the stator coil 413 of the stator windings 40 is inserted. The slot opening is so formed that the circumferential width thereof is almost equal to or somewhat wider than those of conductors of stator coil to be inserted into each slot. This embodiment employs an open-slot stator. Therefore, in order to prevent a coil inserted in each slot from moving toward the opening (the inner periphery side of the stator), a support lid 416 is inserted between the tips of adjacent teeth 414. The support lid 416 is made of a nonmagnetic material such as resin or nonmagnetic metal. Receiving grooves 417 are formed in both side faces of the tip of each tooth 414, and each support lid 416 is axially inserted through two opposing receiving grooves 417 provided at both sides of each slot opening (see FIG. 29). It is noted here that, in the following descriptions of stator windings 40 according to embodiments of the present invention, the portions of a coil positioned inside and outside the stator core 412 (or the slot 411) are sometimes referred to as “slot portion” and “coil end portion”, respectively.

Next, the stator coil 413 of the stator windings 40 will be described with reference to FIGS. 4, 8 and 9. Firstly, one phase of the three-phase stator windings 40 of this embodiment will be explained. The stator coil 413 of this embodiment is wound using a conductor called “rectangular wire” covered with an insulating coating and having a substantially rectangular cross section. When the conductor is wound on the stator core 412, a long side in rectangular shape of the conductor is disposed circumferentially to the stator core 412 and a short side in rectangular shape of the conductor is disposed radially. As described above, an insulating coating is applied to the surface of the conductor used for the stator coil 413.

The interconnection of the stator windings 40 will be described with reference to FIG. 4. As mentioned before, FIG. 4 is a system diagram of an example of an electrical connection used in a rotary electric machine. The stator windings 40 of this embodiment have a pair of parallel connected stator coils 413 for each phase, therefore having a pair of star connections. Denote the pair of star connections as Y1 and Y2 connections respectively, then the Y1 connection includes a U-phase winding Y1U, V-phase winding Y1V and W-phase winding Y1W. Similarly, the Y2 connection includes a U-phase winding Y2U, V-phase winding Y2V and W-phase winding Y2W. The Y1 and Y2 connections are parallel connected, and the respective neutral points thereof are also connected to each other.

The stator coil Y1U includes serially connected sub-coils U11, U12, U13 and U14. The stator coil Y2U includes serially connected sub-coils U21, U22, U23 and U24. The stator coil Y1V includes serially connected sub-coils V11, V12, V13 and V14. The stator coil Y2V includes serially connected sub-coils V21, V22, V23 and V24. The stator coil Y1W includes serially connected sub-coils W11, W12, W13 and W14, while the stator coil Y2W includes serially connected sub-coils W21, W22, W23 and W24. As shown in FIG. 4, each of the sub-coils U11-W24 further includes a pair of element coils. For example, the sub-coil U11 includes serially connected element coils 2 and 1. Here, the reference numerals 1 and 2 of the element coils 1 and 2 represent slot numbers in which they are inserted on the rotor side of the stator core. That is, the sub-coil U11 is composed of serially connected element coils respectively inserted in slots No. 2 and No. 1. And, the sub-coil U12 is composed of serially connected element coils respectively inserted in slots No. 38 and No. 37. Similarly, the reference numerals of the other element coils of FIG. 4 represent respective slot numbers in which they are inserted on the rotor side of the stator core. The last sub-coil W24 is composed of serially connected element coils respectively inserted in slots No. 11 and No. 12. Here it is noted that a pair of serially connected element coils composing each sub-coil are inserted in adjacent slots. As will be described later, such a configuration facilitates manufacturing the stator windings and has an advantage of reducing torque ripple. The manner in which the above-mentioned coils are wound will be detailed later.

As all of the stator coils Y1U, Y1V, Y1W, Y2U, Y2V and Y2W have a similar configuration, the stator coil Y1U is described as being representative thereof with reference to FIG. 8. FIG. 8 is a schematic illustration showing a perspective view of a stator coil 413 comprising the stator windings 40 formed of a single continuous insulated conductor.

The stator coil Y1U, which represents the structure of the stator coil 413, is composed of serially connected sub-coils U11, U12, U13 and U14. These sub-coils are circumferentially equally spaced, and therefore adjacent sub-coils are circumferentially spaced apart from each other by a mechanical angle of 90°. Each sub-coil is composed of two element coils 4131a and 4131b, where the element coil is a basic coil component wound around the stator core through two different slots one turn or multiple turns. Hereinafter, such a basic coil component is always referred to as an element coil. The element coil 4131a is wound through the rotor side of slot No. 2 and the bottom (outer periphery) side of slot No. 7. In addition, it is wound through slots No. 2 and No. 7 multiple turns (three turns in this embodiment). Further, this winding is carried out using a continuous conductor wire, and therefore there is no need for connection work in winding the element coil 4131.

The element coil 4131b of the sub-coil U11 is wound three turns through the rotor side of slot No. 1 and the bottom side of slot No. 6. The element coils 4131a and 4131b are each wound multiple turns through the rotor side of a corresponding first slot and the bottom side of a corresponding second slot. The element coils 4131a and 4131b are serially connected to each other via an inter-element-coil connection line 4134. This element coils (4131a and 4131b) and the inter-element-coil connection line 4134 for connecting them are also integrally wound together using a continuous conductor wire, and therefore there is no need for additional connection work for the inter-element-coil connection line 4134. Each element coil 4131 wound through respective two slots assumes a substantially hexagonal shape when fitted in the stator core 412, and the both coil ends thereof are each wound in such a manner to be extended between the rotor (inner periphery) side of a slot 411 and the bottom (outer periphery) side of another slot 411. The stator windings 40 employ a distributed winding, where the number of slots by which neighboring slots belonging to the same phase (for example, slots No. 2 (1) and No. 7 (6)) are circumferentially spaced apart from each other varies depending on the total number of slots and poles of a stator.

As described above, the element coils 4131a and 4131b are each wound of a continuous conductor wire, thus reducing the number of connection points which need connecting work. Furthermore, the element coils (4131a and 4131b) and the inter-element-coil connection line 4134 for connecting them can also be integrally wound together using a single continuous conductor wire as will be described later. Thus, with this embodiment, the number of turns of the stator coil 413 can be increased while suppressing increase in the number of parts which need connecting work.

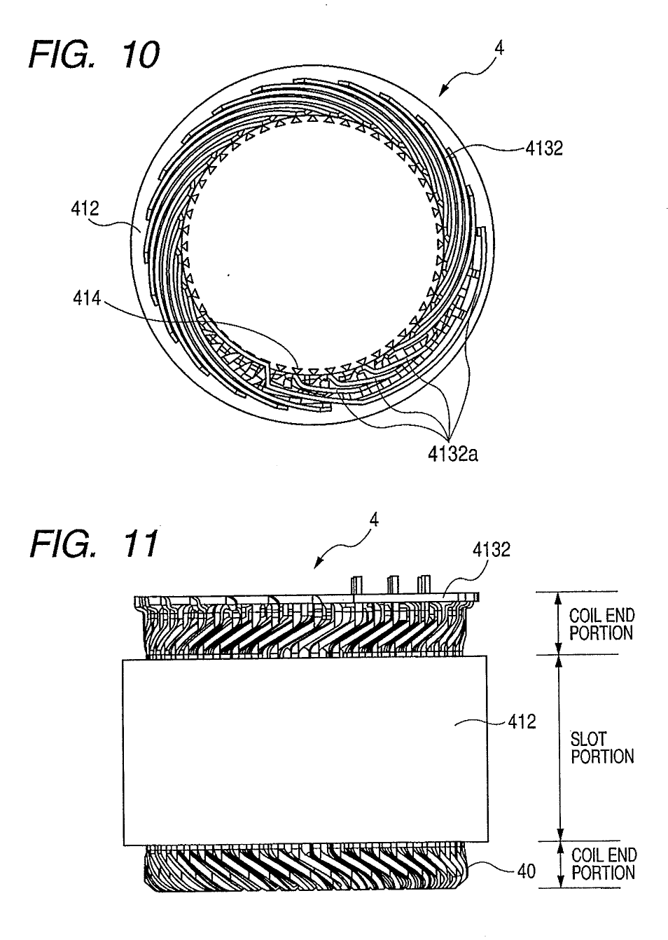

In addition, a plurality of (four, in this embodiments) sub-coils 4131 (pairs of element coils 4131a and 4131b) are circumferentially equally spaced from one another by an angle of 90°, where the tops of the coil ends of neighboring sub-coils are connected to each other via a crossover line 4132. And, the four sub-coils are wound of a single continuous conductor. Further, the crossover lines 4132 are provided on only one axial end face of the stator 4. Furthermore, the crossover lines 4132 are spirally extended between the inner and outer periphery sides of the stator core 412 as viewed in the axial direction, as shown in FIG. 10. FIG. 10 is a schematic illustration showing a front view of the stator viewed in the axial direction.

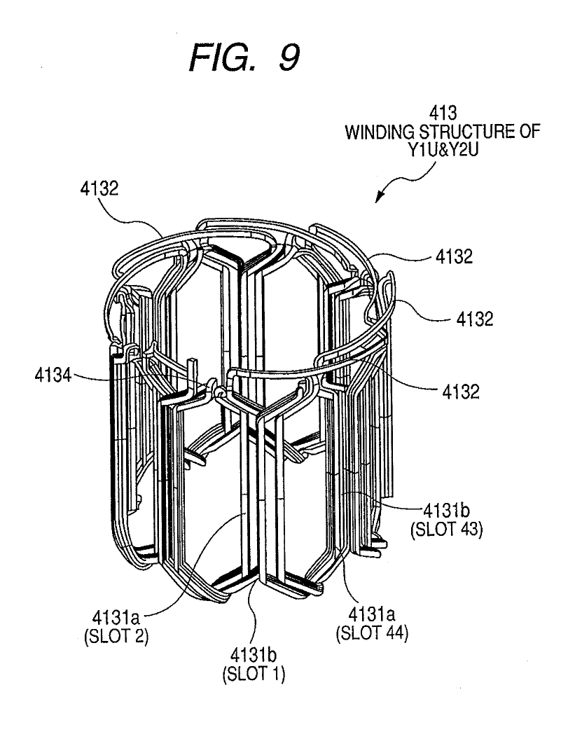

The single coil shown in FIG. 8 is a half of one phase of the stator windings 40. As shown in FIG. 9, one phase of the stator windings 40 is composed of: the stator coil Y1U described in FIG. 8; and the stator coil Y2U having the same structure as the coil Y1U and is disposed to be circumferentially shifted from the coil Y1U by a mechanical angle of 45°. That is, a pair of element coils 4131a and 4131b of the stator coil Y2U is formed similarly to those of the stator coil Y1U, and are disposed to be circumferentially shifted from a corresponding pair of the stator coil Y1U by a mechanical angle of 45°. The element coil 4131a of the sub-coil U11 is inserted in the rotor side of slot No. 2 and the element coil 4131b of the sub-coil U11 is inserted in the rotor side of slot No. 1. On the other hand, the element coil 4131a of the sub-coil U21, which is disposed to be circumferentially shifted from the corresponding one of the sub-coil U11 by a mechanical angle of 45°, is wound through the rotor side of slot No. 44 and bottom side of slot No. 1. And, the element coil 4131b of the sub-coil U21 is wound through the rotor side of slot No. 43 and bottom side of slot No. 48.

FIG. 9 is a schematic illustration showing a perspective view of stator coils 413 of one phase. The stator windings 40 of all the three phases are composed of: a first stator coil 413 formed as described in FIG. 9; a second stator coil 413 having the same structure as that of the first stator coil 413 and disposed to be shifted from the first stator coil 413 by a mechanical angle of 15°; and a third stator coil 413 having the same structure as that of the first stator coil 413 and disposed to be shifted from the first stator coil 413 by a mechanical angle of 30°. Thus, with this embodiment, the three-phase stator windings 40 can be wound around the stator core 412 in such a configuration as to reduce the number of connection points which need connecting work. As shown in FIG. 10, each crossover line 4132 is extended between the outer and inner peripheries of the stator core 412 such that all the crossover lines 4132 are disposed in a substantially spiral arrangement. The neutral points of the star connections need to be connected to each other by a separate crossover wire 4132a by means of, e.g., TIG (tungsten inert gas) welding. The crossover wire 4132a serving as the neutral point is also extended between the inner and outer periphery sides of the stator core 412. Such a configuration allows the stator coils 413 to be disposed in an orderly arrangement, which enable efficient space utilization, resulting in downsizing of a rotary electric machine.

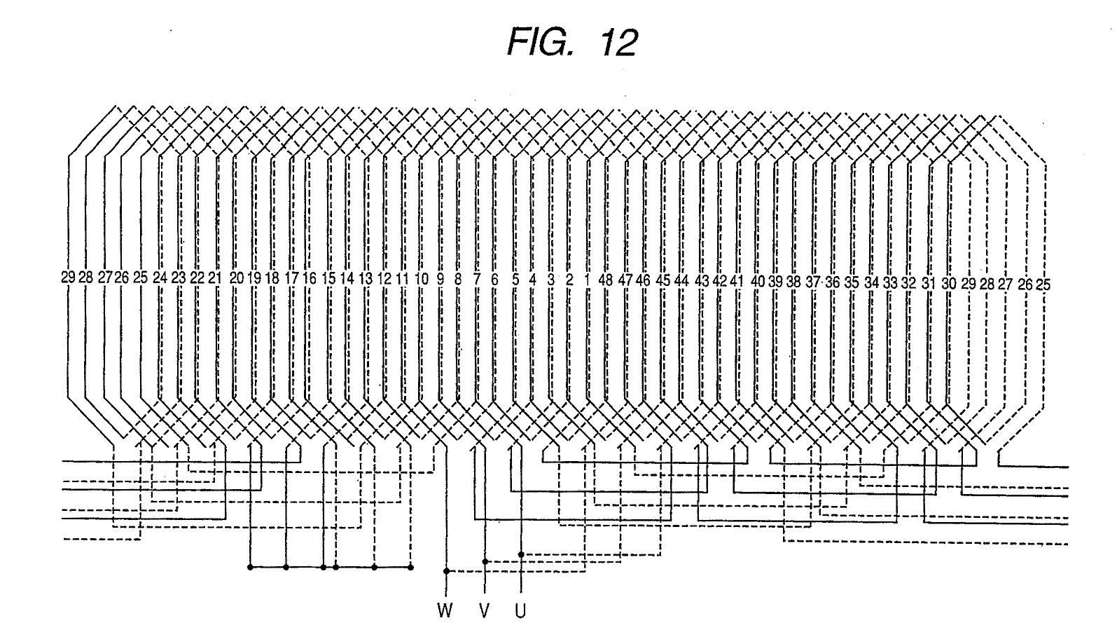

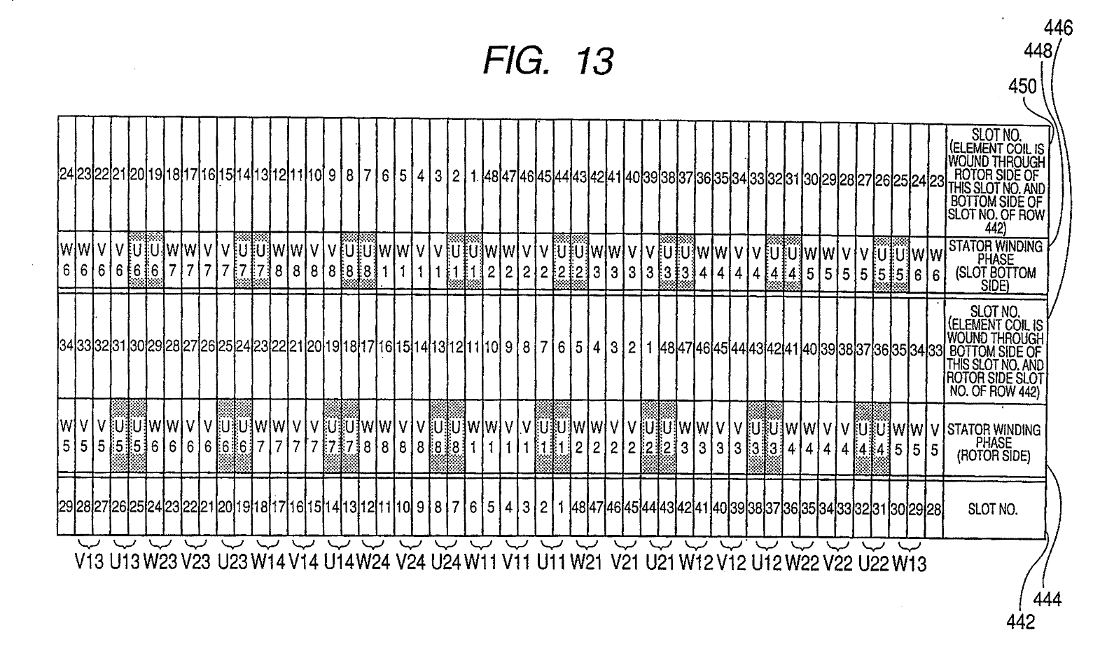

FIG. 13 shows a relationship between stator slot number and element coil of the stator windings 40. A row 442 of the figure indicates slot numbers, in which 48 slots are sequentially numbered starting from a preselected slot. The sub-coils U11-W24 of the stator coils 413 are each composed of two element coils, which are respectively wound through the rotor side of two slots having slot numbers shown in FIG. 4. The relationship between sub-coil and slot number is shown in and below the row 442. For example, the sub-coil W13 in the row 442 is associated with the slot numbers 29 and 30. This indicates that the sub-coil W13 is composed of serially connected element coils: one which is wound through the rotor side of slot No. 29; and the other which is wound through the rotor side of slot No. 30. This is also known from FIG. 4, in which the sub-coil W13 is associated with element coil Nos. 29 and 30. In the row 442 of FIG. 13, the sub-coil U22 corresponds to slot Nos. 31 and 32, which indicates that the sub-coil U22 is composed of serially connected element coils: one which is wound through the rotor side of slot No. 31; and the other which is wound through the rotor side of slot No. 32. This is also known from FIG. 4, in which the sub-coil U22 is associated with element coil Nos. 31 and 32. The sub-coil U11, which has been described in FIG. 8, is associated with slot Nos. 1 and 2. This indicates that the coil U11 is composed of serially connected element coils: one which is wound through the rotor side of slot No. 1; and the other which is wound through the rotor side of slot No. 2. This is also known from FIG. 4, in which the sub-coil U11 is associated with element coil Nos. 1 and 2.

The row 444 of FIG. 13 shows the phases of the element coils and the arrangement order thereof in each phase. In the row 442, the sub-coil U11 is associated with slot Nos. 1 and 2. This, as described above, indicates that the sub-coil U11 is composed of serially connected element coils respectively wound through the rotor sides of slot Nos. 1 and 2. In the row 444, the element coils of the sub-coil U11 are both represented as “U1”. The “U1” means the first (or reference) sub-coil position of the U-phase stator coils 413. The element coils of the sub-coil U21 are both represented as “U2”, in the row 444. This means that the sub-coil U21 is arranged in the second position, or is arranged to be shifted counterclockwise from the U-phase first sub-coil position by a mechanical angle of 45°. Likewise, both of the element coils of the sub-coil U12 are represented as “U3”, in the row 444. This similarly indicates that the sub-coil U12 is arranged in the third position, or is arranged to be shifted counterclockwise from the U-phase first sub-coil position by a mechanical angle of 90°. This is just what has been already explained with reference to FIG. 8.

The sub-coil V11 is arranged to be shifted counterclockwise relative to the sub-coil U11 by a mechanical angle of 150. The sub-coil V21 is associated with “V2” in the row 444; therefore, it is arranged to be further shifted counterclockwise by a mechanical angle of 45° from the coil V11 which is shifted from the sub-coil U11 by 150. All the other V-phase sub-coils are also arranged relative to the sub-coil V11, and therefore are arranged to be shifted counterclockwise from the corresponding U-phase sub-coils by 15°. Similarly, the sub-coil W11 is arranged to be shifted counterclockwise relative to the sub-coil U11 by a mechanical angle of 30°; therefore, all the W-phase sub-coils are arranged to be shifted counterclockwise from the corresponding U-phase sub-coils by 30°.

The row 446 will be next explained. In this embodiment, each element coil 4131 has a structure of being wound around two slots. That is, the element coil 4131a of FIG. 8 is wound through the rotor side of one of the two slots (slot No. 2) and the bottom side of the other (slot No. 7). In FIG. 13, each element coil is wound through the rotor side of a slot in the row 442 and the bottom side of another slot in the same column of the row 446. Namely, slot No. 2 in the row 442 corresponds to slot No. 7 in the row 446. This indicates that an element coil is wound around the stator core through the rotor side of slot No. 2 and the bottom side of slot No. 7. All the other numbers in the rows 442 and 446, similarly, indicate pairs of slot numbers through which the element coils are wound around the stator core.

The row 448 indicates the phases of the element coils inserted in the bottom side of the slot Nos. in the row 442 and the arrangement order thereof in each phase. The row 450 shows slot Nos. through which the element coils in the row 448 is wound. For example, the row 448 indicates that the element coil inserted in the bottom side of slot No. 2 listed in the row 442 is in the second position of the V-phase winding. Further, the number “45” in the row 450 means that the element coil inserted in the bottom side of slot No. 2 is wound through slot Nos. 45 and 2. Slot No. 45 in the row 442 corresponds to slot No. 2 in the row 446. This represents the same element coil as the above-mentioned one. Namely, they both indicate that the element coil wound through slot Nos. 45 and 2 is one of the element coils arranged in the V-phase second position.

FIG. 12 is an overall interconnection diagram of the 2Y-connected stator windings 40 shown in FIG. 4. Note that the element coils 4131 are shown to be wound one turn in FIG. 12, but they actually are wound three turns as described above. In FIG. 12, the numbers shown in the centers of the element coils 4131 represent the slot numbers, where the dashed line represents the element coil inserted in the inner periphery (opening side) of the slot, and the solid line the element coil inserted in the outer periphery (bottom side) of the slot. In addition, intersections of two lines marked with black dots represent points which need to be connected by welding. As is apparent from FIG. 12, there are only nine points that need to be connected by welding.

In the structure explained in FIGS. 4 and 13, a plurality of conductors are stacked in the radial direction in each slot, and these conductors are wound around the stator core through two slots to form an element coil. In this embodiment, each element coil is wound of a single continuous conductor; therefore, the number of turns can be increased while suppressing increase in the number of connection points that need connecting work, thereby facilitating manufacturing the stator coil. In addition, the conductor is circumferentially long and radially thin in shape, thus suppressing eddy current generated in the conductor in a slot caused by leakage flux. This in turn improves efficiency of a rotary electric machine and suppresses heat generation.

FIG. 11 is a schematic illustration showing a side view of the stator 4. As shown in FIG. 11, the crossover lines 4132 are accommodated within a substantially same axial thickness from the end face of the stator core, and thus the coil end can be thinned. As described above (see FIG. 10), this embodiment winds the crossover lines axially over the coil ends of element coils, which enables orderly overall arrangement, in turn leading to an overall downsizing of a rotary electric machine. Moreover, such a configuration can ensure reliability such as insulation properties. In particular, recent rotary electric machines for vehicles operate at high voltages (typically above 100V, in some cases, 400 to 600V); therefore, insulation reliability between lines of stator windings is a critical problem.

In addition, the above embodiment connects, by the inter-element-coil connection line 4134, the multi-turn element coils 4131a and 4131b to each other. The crossover lines 4132 are wound axially over the inter-element-coil connection lines 4134, thus providing an orderly overall arrangement. Similarly as above, this also can reduce the overall size of a rotary electric machine. Also, reliability such as insulation properties can be ensured.

Advantages of stator windings according to below-detailed embodiments can be broadly summarized as follows.

With an embodiment of the present invention, there can be employed stator winding conductors having a substantially rectangular cross section as well as ones having a circular cross section, and therefore the space is factor of winding conductors in a slot can increase, thus improving the efficiency of a rotary electric machine. In conventional rotary electric machines, use of such conductors having a substantially rectangular cross section presents a productivity problem because there are many points that need to be electrically connected after the conductors have been inserted in slots. In below-described embodiments, a plurality of stator coils, each including a plurality of element coils and being wound of a continuous insulated conductor, are inserted in slots; therefore, the required number of electrical connection points can be reduced, thus enhancing productivity of the stator coil.

In addition, one side of each element coil is inserted in the bottom side of a slot, and then the other side thereof is inserted in the opening side of another slot after the distance between the both sides of the element coil is adjusted to a predetermined length; thereby, the plurality of continuously wound coils can be efficiently inserted in slots, providing improved productivity.

Further, one side of each element coil, which is lap wound of a continuous wire, is inserted in the inner periphery side of a first slot, and the other side thereof is inserted in the outer periphery side of a second slot that is circumferentially spaced apart from the first slot by a predetermined number of slots, and therefore the coil end thereof is wound to be extended between the inner periphery side of the first slot and the outer periphery side of the second slot. Such a configuration can arrange a plurality of element coils in an orderly manner, which can increase the number of turns of each element coil while suppressing increase in the required number of electrical connection points that may accompany the increase in the number of the turns. Additionally, increase in size of a rotary electric machine can be suppressed even if the number of turns of each element coils increases.

Furthermore, each slot has a plurality of conductor portions of a lap wound element coil inserted in the radial direction, but only one in the circumferential direction. Such a configuration facilitates a manufacturing step of inserting each continuously wound element coil in a slot, thus enhancing productivity. Moreover, a pair of element coils, which have the same phase and through which current flows in the same direction, are inserted in two neighboring slots, thus providing a rotary electric machine structure leading to improved productivity. Further, a plurality of pairs of element coils, each pair having the same phase and being inserted in two neighboring slots, are serially connected to provide a stator coil, and thereafter a plurality of the stator coils are electrically connected to each other to provide stator windings. Hence, the stator windings according to the preferred embodiments described below have an advantage of facilitating a balancing of electrical properties.

Stator windings according to below-described embodiments can be applied to permanent magnet electric motors as well as induction motors. The following embodiments will be described with reference to an eight-pole induction motor as an example of an application of the present invention. The radial thickness of the core back of a stator core can be thinned by increasing the number of the poles of an induction motor to six or more, particularly eight or ten. Also, the radial thickness of the magnetic circuit of a rotor yoke can be thinned by increasing the number of the poles of an induction motor to six or more, particularly eight or ten. The number of poles of an induction motor for driving a vehicle is preferably six to ten, more preferably eight to ten, most preferably eight.

### First Embodiment of the Invention

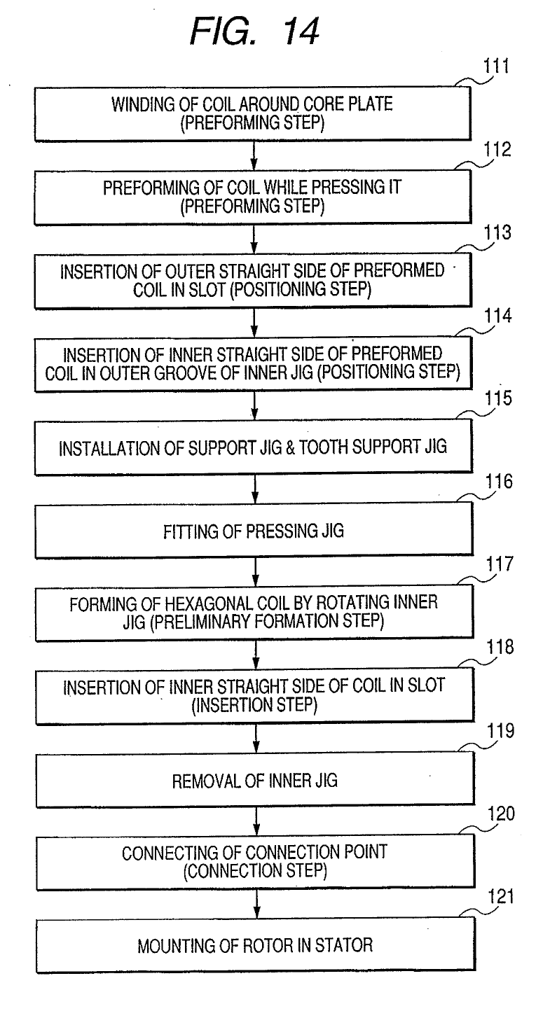

A manufacturing method of a rotary electric machine according to a first embodiment of the present invention will now be described with reference to FIGS. 14-29. A method for inserting coils in stator slots, which is one feature of this embodiment, will be described.

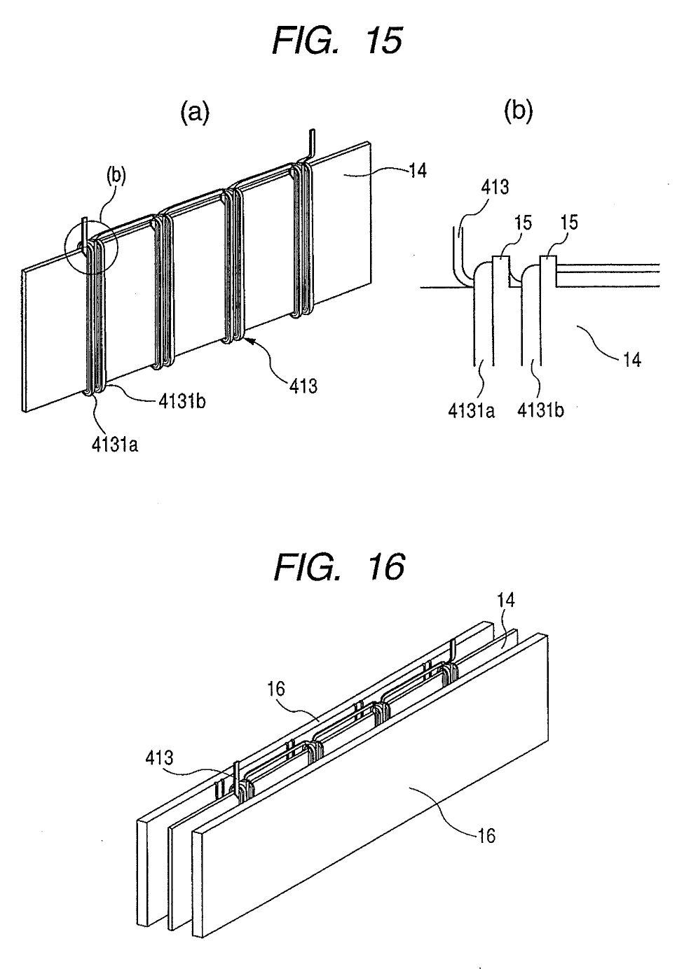

FIG. 14 is a flow chart for explaining an example of manufacturing steps according to a first embodiment of the present invention. FIGS. 15(a) and 15(b) are schematic illustrations for explaining a method for forming oval shaped element coils, according to the first embodiment. FIG. 15(a) is a perspective view of a stator coil wound around a core plate; and FIG. 15(b) is an enlarged view of the encircled part (b) in FIG. 15(a). In the manufacturing method of this embodiment, a step 111 of the FIG. 14 flow chart firstly winds an insulated conductor such as an enamel wire around a core plate 14 several turns to form element coils 4131a and 4131b. As shown in FIG. 15(a), the core plate 14 is a thin plate with the edges rounded. And, four pairs of adjacent fagot pins 15 are substantially equally spaced along the thin surface on the longitudinal side of the core plate, as shown in FIG. 15(b).

Then, the insulated wire is extended from one end of the longitudinal side of the core plate 14, is routed around a first fagot pin 15 and is wound around the core plate several turns (three turns in this embodiment) by utilizing the first fagot pin 15, thereby forming a spiral element coil 4131a. Thereafter, the insulated wire is further routed around a second fagot pin 15 adjacent to the first one and is similarly wound around the core plate several turns (three turns in this embodiment) by utilizing the second fagot pin 15, thereby forming a pair of element coils 4131a and 4131b. Thus formed element coils 4131a and 4131b are each spirally wound from the inside to the outside; therefore, the outermost turn of the element coil 4131a is continuously extended to the innermost turn of the element coil 4131b.

After the winding of the pair of element coils 4131a and 4131b has been completed, the resulting end of the insulted wire comes out of the outermost turn of the spiral element coil 4131b. From this end of winding, the insulted wire is further extended, along the thin surface on the longitudinal side of the core plate 14, to a length corresponding to eleven times the circumferential pitch of the slot openings (or corresponding to a mechanical angle of 90°). The insulated wire is then routed around the next fagot pin 15, and is wound around the core plate similarly as described above. That is, four pairs of such fagot pins 15 are provided along the longitudinal side of the core plate at a spacing corresponding to the circumferential length of the stator core inner periphery subtending a mechanical angle of 90°. A similar winding operation to that described above is repeated four times at each pair of fagot pins 15, and thereby a stator coil 413 including four pairs of element coils 4131a and 4131b is wound around the core plate 14 as shown in FIG. 15(a).

As shown in the FIG. 14 flow chart, the step 112 presses the stator coil 413, thereby completing the preforming. Thus, the preforming step includes the steps 111 and 112 of the FIG. 14 flow chart. The pressing procedure is performed as follows. Firstly, the stator coil 413 wound around the core plate 14 is clamped and pressed, in the thickness direction, by two pressing blocks 16 having a substantially same shape as the core plate 14, as shown in FIG. 16. FIG. 16 is a schematic illustration showing a perspective view in which oval shaped element coils (stator coil) wound around the core plate are then being pressed according to the first embodiment. Thereby, it can remove any bulge on both sides of the element coils. Preferably, a self-bonding wire is used for the stator coil 413 in order to bond adjacent wire portions together by energizing the wire, thereby facilitating the succeeding manufacturing operations. Further, insulating papers may be placed across the coil insertion openings of the slots, and thereafter the stator coil and the insulating papers may be bonded together by energizing the self-bonding wire. Integrally bonding the stator coil 413 and the insulating papers together in such a manner facilitates the succeeding manufacturing operations as well as prevents damage of the coating surface of the coil when being inserted in the slots 411.

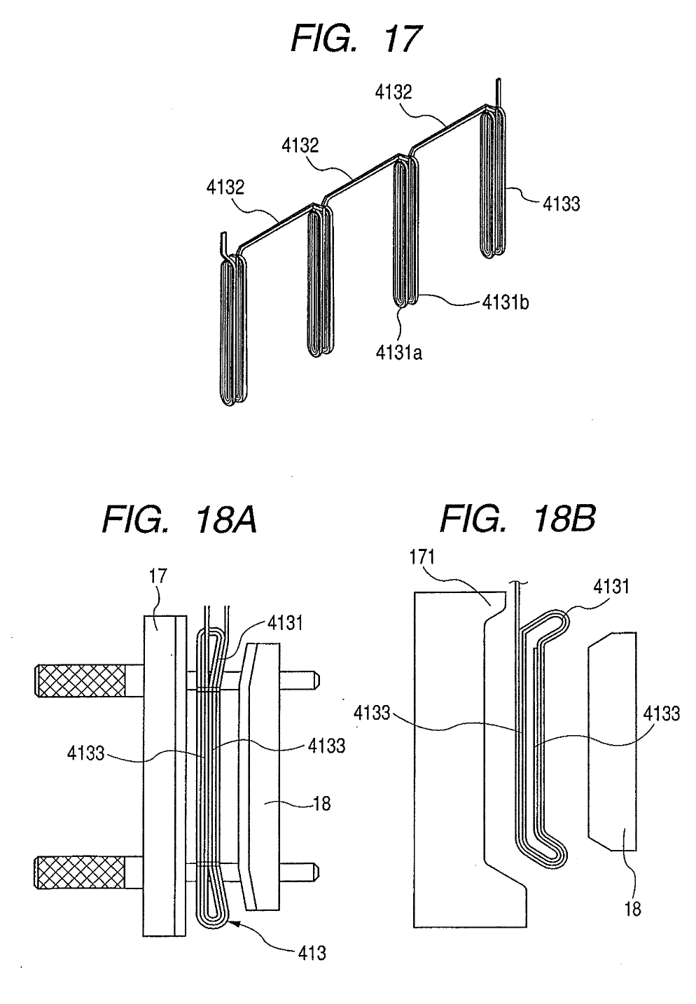

Then, the stator coil 413 is removed from the core plate 14. The removal can be performed, for example, in the following manner: detachable fagot pins may be used; the core plate 14 may be formed of several partial plates divided in the height direction such that the height of the core plate 14 can be adjusted when removing the stator coil 413; or the fagot pins 15 may be configured to be retractable into the core plate 14. FIG. 17 is a schematic illustration showing a perspective view of a stator coil preformed according to the first embodiment. As shown in FIG. 17, the stator coil 413 thus removed from the core plate 14 has four pairs of oval-shape element coils (4131a 4131b) each being spirally wound several turns (three turns in this embodiment) and having a pair of straight sides, in which adjacent pairs are continuously connected via a crossover line 4132.

Additionally, the straight sides of each oval-shaped element coil 4131 may be pressed in the direction perpendicular to the straight sides, as shown in FIG. 18(A). FIGS. 18(A) and 18(B) are schematic illustrations showing side views in which the preformed stator coil is further deformed according to the first embodiment. The pressing is carried out using a flat plate die 17 and a substantially trapezoidal punch 18. Each oval-shape element coil 4131 is clamped and pressed between the die 17 and punch 18 so that the both coil ends thereof are formed in a substantially P-shape. The stator coils 413 are inserted in the slots so that the projecting side of the P-shaped coil ends of the element coils 4131 faces toward the outer periphery side of the stator core 413, thereby preventing the stator coils 413 from projecting toward the inner periphery side and interfering with insertion of a rotor 5.

FIG. 18(B) shows another possible alternative for preventing inward projection of the stator coils 413. In FIG. 18(B), a die 171 has a concave portion of a substantially trapezoidal shape generally complementary to the shape of the punch 18. When the oval-shape element coil 4133 is pressed between the die 117 and punch 18, the both coil ends thereof extending between the both straight sides thereof are bent toward one direction, obtaining an overall shape of a square bracket. The stator coils 413 are inserted in the slots so that the projecting side of the square-bracket-shaped coil ends of the element coils 4131 faces toward the outer periphery side of the stator core 413, thereby more securely preventing inward projection of the stator coils 413 as well as also enabling reduction in the height of the coil ends. By all these procedures, the step 112 for preforming the stator coil 413 is completed.

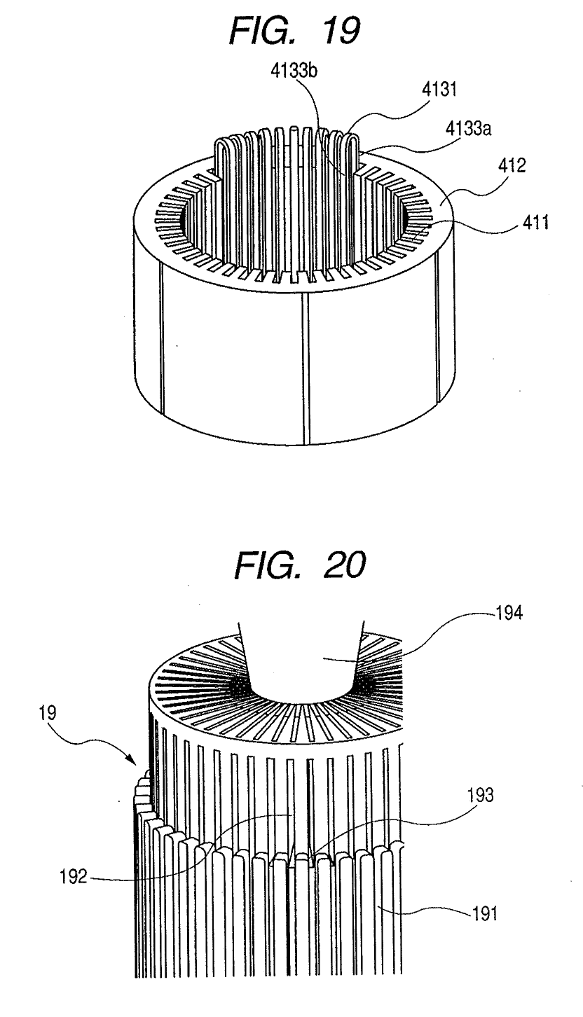

Next, in the step 113 of the FIG. 14 flow chart, the preformed element coils 4133 are circularly positioned such that their outer straight sides 4133a (which will be inserted in the outer periphery side of a slot) face the corresponding slot openings of the stator core 412. That is, the shorter axes of the oval-shape element coils 4131 are radially positioned. This positioning procedure needs to be performed while deforming the crossover lines 4132 extending between neighboring pairs of element coils 4131a and 4131b. This series of procedures is involved in the positioning step. FIG. 19 is a schematic illustration showing a perspective view in which the stator coil preformed according to the first embodiment is inserted in the slots of the stator core. Specifically, the outer straight sides 4133a of the element coils 4131 are inserted in the slots of the stator core 412. For easy understanding, FIG. 19 shows only some of the element coils 4131 inserted in the slots 411 and also does not show the crossover lines 4132.

In addition, in the positioning step 113, the element coils are inserted in the slots such that the projecting side of the coil ends thereof (which have been formed by deforming the element coils as described in FIG. 18(A) or 18(B)) faces the outer periphery side of the stator core 412. Further, the outer straight sides 4133a of a first pair of adjacent element coils 4131a and 4131b are respectively inserted in a first pair of adjacent two slots 411, while the outer straight sides of a second element coil pair (which is extended from the first element coil pair via a crossover line 4133) are respectively inserted in a second pair of adjacent two slots 411 which are circumferentially spaced apart by 90° from the first slot pair. Similarly, the outer straight sides 4131a of the other continuously preformed element coils 4131 are axially inserted in the remaining slots of the stator core; as a result, all the outer straight sides 4131a of the element coils of the three-phase stator windings 40 are inserted in all of the slots 411.

The crossover lines 4132 for connecting neighboring pairs of element coils of the stator coil 413 to each other are placed to be extended between the outer and inner peripheries of the stator core 412 in a substantially spiral manner as shown in FIGS. 7 and 10. In addition, they are preferably formed to be axially bulged outwardly, e.g., in a substantially V or U shape, thereby facilitating the succeeding manufacturing operations. The details will be described later.

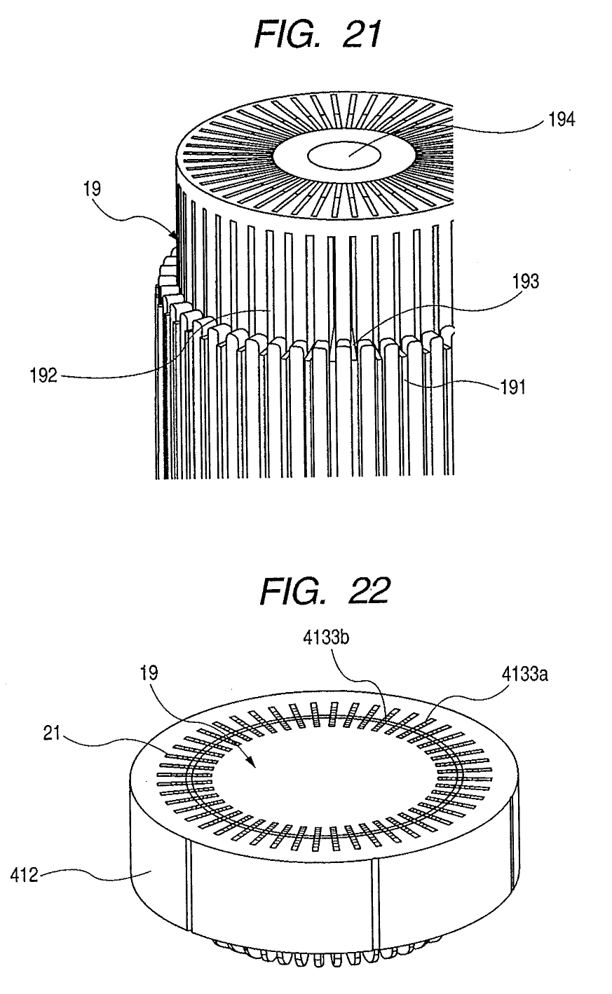

Next, in the step 114 of FIG. 14 flow chart, an inner jig 19 is axially inserted into the bore of the stator core 412 such that the inner straight side 4131b of each element coil 4131 is inserted in an outer groove of the inner jig 19. The positioning procedure involves the steps 113 and 114 of FIG. 14 flow chart. The inner jig 19 will now be detailed with reference to FIGS. 20 and 21. FIG. 20 is a schematic illustration showing a perspective view in which pushing members of the inner jig used in the first embodiment are retracted. FIG. 21 is a schematic illustration showing a perspective view in which the pushing members of the inner jig are projected.

As shown in FIG. 20, the inner jig 19 has, on its outer periphery, outer grooves 191 of the same number as the slots 411 of the stator core 412. The outer grooves 191 and slots 411 face each other one to one. The circumferential width of the outer groove 191 is somewhat smaller than or equal to that of the opening of the slot 411, while the axial length thereof is longer than that of the slot 411. Further, at the bottom (at the inner periphery side) of the outer groove 191 there is formed a slit 192, through which a plate-like pushing member 193 is provided such that it can be radially protruded and retracted. On the further inner periphery side of the pushing members 193, there is axially movably provided an enlarging member 194. The enlarging member 194 has a tapered surface continuously slanting toward the insertion direction. When the enlarging member 194 is inserted in the inner periphery side of the pushing members 193, the pushing members 193 are projected through the slits 192 caused by a cam action of the tapered surface thereagainst, as shown in FIG. 21.

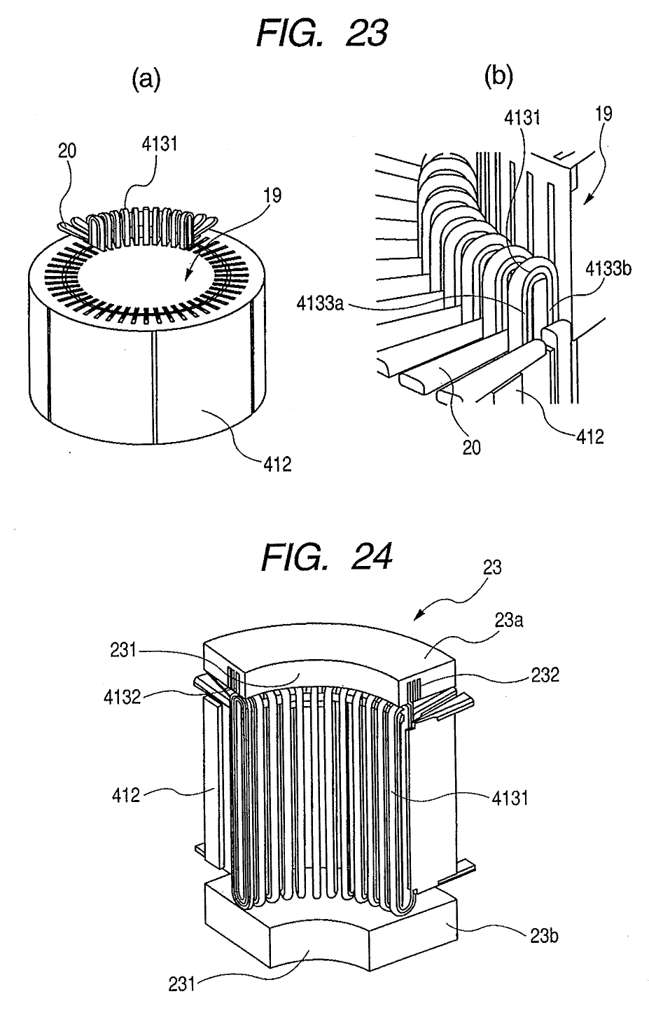

Thus configured inner jig 19 is axially inserted in the bore of the stator core 412 such that the inner straight sides 4131b of the element coils 4131 are inserted in the respective outer grooves 191. FIGS. 23(a) and 23(b) are schematic illustrations showing a perspective view in which the preformed stator coils 4131 are inserted in the slots of the stator core 412, thereafter the inner jig 19 is inserted in the bore of the stator core 412, and support jigs 20 are then fitted between adjacent preformed stator coils 4131, according to the first embodiment. For easy understanding, FIG. 23(a) shows only some of the element coils 4131 inserted in the slots 411 and also does not illustrate the detail of the inner jig 19 or the crossover lines 4132. FIG. 23(b) is a schematic illustration showing an enlarged view of a part of FIG. 23(a). As is apparent from FIG. 23(b), the axial length of the inner jig 19 is longer than that of the slot 411 as has been already described. Therefore, the axial length of the outer groove 191 is also longer than that of the slot 411.

As shown in the step 115 of FIG. 14 flow chart, support jigs 20 and tooth support jigs 21 are installed on and in the stator core 412, respectively. Firstly, the tooth support jigs 21 of a rod-like shape conforming to the slot 411 are axially inserted into gaps between the bottoms of the slots 411 and outer straight sides 4133a of the element coils 4131. FIG. 22 is a schematic illustration showing a perspective cross-sectional view of the stator core 412 in which tooth support jigs 21 are inserted in each slot 411, with the upper part thereof removed. The reason of inserting the tooth support jigs is as follows. When a circumferential force is applied to the outer straight sides of the element coils 4131, it causes the tooth 414 to circumferentially bend and collapse; however, the tooth support jigs 21 inserted in the respective slots 411 are able to prevent such collapse of the teeth 411. Thus, when the outer straight sides 4133a of the element coils 4131 receives a circumferential force in the succeeding preliminary formation step, collapse of the tooth 414 can be prevented.

Furthermore, as shown in FIG. 23, the rod-like support jigs 20 somewhat tapered toward its insertion end is radially inserted from the outside into all gaps between adjacent straight sides 4133a of the element coils 4131 which axially project out of the both end faces of the stator core 412. As shown in FIG. 23(b), a surface of the support jig 20 contacting the axial end surface of the stator core 412 is flat and the opposite surface is round; therefore the support jig 20 has a substantially semicylindrical overall form. And, when the support jig 20 is inserted, the round surface thereof is coplanar with the axial end of the outer groove of the inner jig 19 (refer to FIG. 20).

Next, at the step 116 of FIG. 14 flow chart, press jigs 23 are fitted to the stator core 412. FIG. 24 is a schematic illustration showing a perspective partial cross-sectional view in which press jigs are fitted to the stator core. As shown in FIG. 24, the press jigs 23 are fitted to both axial end faces of the stator core 412, and can axially press, against the both end faces of the stator core, the tops of both coil end portions extending between both straight sides of the element coils 4131. There are two types of press jigs 23: a press jig 23a on the side at which the crossover lines 4132 are formed, and a press jig 23b on the other side. They are both ring-shaped so that the inner jig 19 can be inserted therethrough. Further, the press jig 23a has, formed on its surface, grooves 232 conforming to the shape of the crossover line 4132. The crossover lines 4132 are inserted in the grooves 232, and thereby the tops of the coil end portions can be pressed simultaneously with adjusting the shape of the crossover lines 4132.

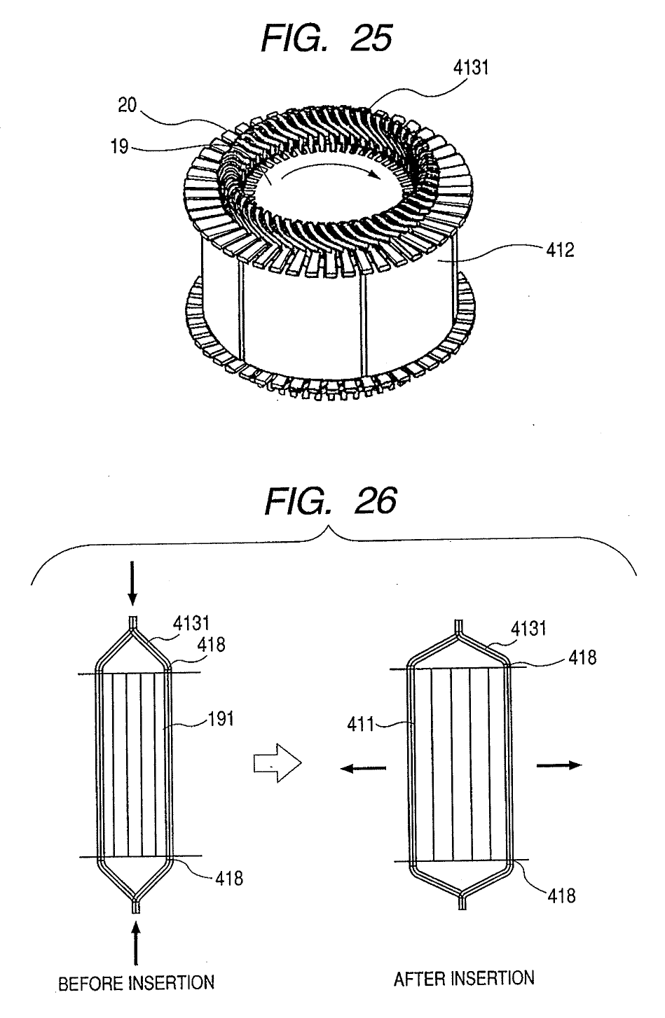

Then, at the step 117 of FIG. 14 flow chart, the inner jig 19 is rotated relative to the stator core 412 in order to laterally expand the element coils 4131. Thereby, the oval shape of the element coil 4131, which may have been preformed as described in FIGS. 18(A) and 18(B), is transformed into a substantially hexagonal shape. This is a preliminary formation step. FIG. 25 is a schematic illustration showing a perspective view of stator windings preliminary formed according to the first embodiment. More specifically, the inner jig 19 is clockwise rotated a predetermined angle while immovably securing the stator core 412 and axially pressing the tops of the coil end portions of the element coils 4131 in the axis direction of the stator core 412 by using the press jigs 23. Here, the inner straight side 4133b of a first element coil 4131 positioned outside the opening of a first slot is rotated to a position outside the opening of a second slot so that the inner straight side 4133b of a first element coil 4131 and the outer straight side 4133a of a second element coil 4131 (which has already been inserted in the second slot) are positioned along the same radius. In this embodiment, the inner straight side 4133b of each element coil 4131 is rotated by five slots 411. That is, the inner straight side 4133b of a hexagonally-shaped element coil 4131 inserted in an outer groove 191 of the inner jig 19 is rotated by five slots 411 where it faces a slot 411 in which the outer straight side 4133a of a different hexagonally-shaped element coil 4133 is inserted. While the inner jig 19 is rotated relative to the stator core 412 in this embodiment, conversely, the stator core 412 may be rotated relative to the inner jig 19.

FIG. 25 shows that all the element coils 4131 are expanded to a substantially hexagonal shape and are arranged in an orderly manner. For easy understanding, the figure does not show the detailed shape of the inner jig 19, the crossover lines 4132 or the press jigs 23. The crossover lines 4132 connect the tops of the coil ends to each other; therefore, even when the element coils 4131 are expanded into the substantially hexagonal shape by rotating the inner jig 19 as described above, the crossover lines 4132 just rotate while their original shape are maintained and therefore are not deformed. That is, the press jigs 23a and 23b in which the crossover lines 4132 are inserted also rotate following the inner jig 19.

This embodiment forms the element coils 4131 into a hexagonal shape while axially pressing them between the press jigs 23, which can distribute stress during the deforming operation to the element coils 4131, thus facilitating the deformation and also preventing damage of an insulating coating such as varnish applied on the surface of the conductor of the stator coil 413. Additionally, the axial height of the coil end portions can be reduced.

Then, at the step 118 of FIG. 14 flow chart, the inner straight sides 4133b of the element coils 4131 are inserted into the slots 411 of the stator core 412. This operation is an insertion step. After the completion of the preliminary formation step and before starting the insertion step, the support jigs 20 and tooth support jigs 21 are removed in advance. Thereafter, the enlarging member 194 is inserted into the bore of the inner jig 19, thereby pushing out the pushing members 193 and as a result causing the inner straight sides 4133b of the element coils 4131 to be inserted into the slots 411 of the stator core 412. The circumferential width of the opening of the slot 411 is equal to or somewhat larger than that of the outer groove 191 and, in addition, the straight side of the element coil 4131 is longer than the axial length the slot 411, thus preventing, in this insertion operation, the element coil 4131 from being caught by the tip of the teeth 414. FIG. 26 is a schematic illustration for explaining how an element coil is deformed during the insertion step of the first embodiment. As shown in FIG. 26, both straight sides of each element coil 4131 have extensions 418 at both axial ends, and when the element coil 4131 is inserted in a slot 411, the extensions 418 axially project out of both end faces of the stator core 412.

In addition, since the slots 411 extend in the radial direction, a distance between both straight sides of the element coil 4131 must be expanded as shown in FIG. 26. Thus, the inner straight sides 4133b are inserted into the slots while clamping the element coils 4131 between the press jigs 23 and axially pressing the tops of both coil ends thereof in a similar manner to that of the preliminary formation step, thereby facilitating the insertion operation as well as reducing the axial height of the coil end portions. Further, when expanding the distance between both straight sides of the element coils 4131, the crossover lines 4132 must be stretched in radial direction. This can be done by straightening the substantially U- or V-shaped axially outward bulge of the crossover lines 4132 which have been preformed in the positioning step.

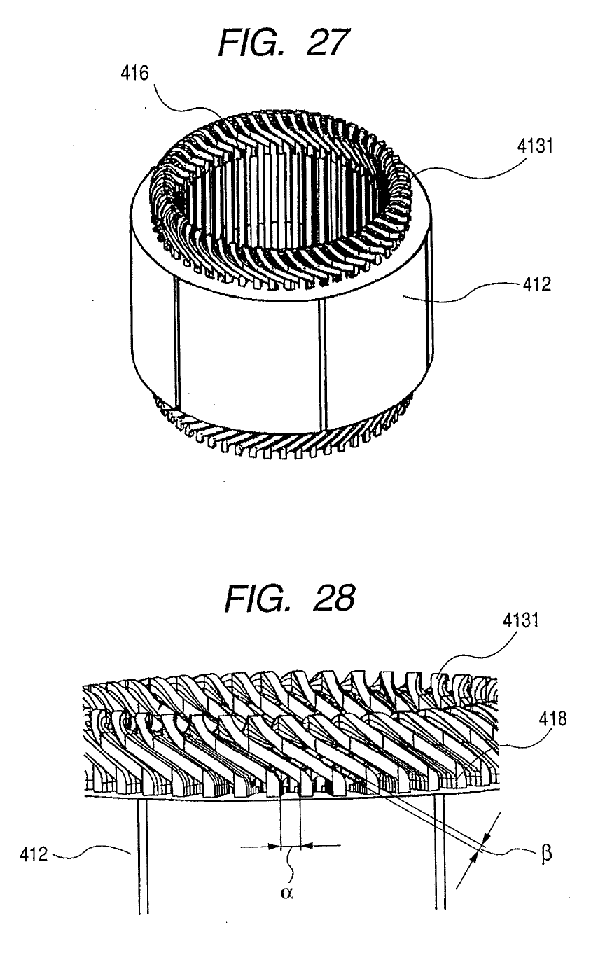

Then, at the step 119 of FIG. 14 flow chart, the press jigs 23 and inner jig 19 are removed and thereafter support lids 416 are axially inserted into receiving grooves 417 provided at the circumferentially opposite surfaces of the tip of the teeth 414 (see FIG. 29). FIGS. 27 and 28 illustrate the stator core 412 from which the press jigs 23 and inner jig 19 have been removed. FIG. 27 is a schematic illustration showing a perspective view in which the stator coils are inserted in the slots of the stator core, according to the first embodiment. FIG. 28 is a schematic illustration showing an enlarged perspective view of the coil end portion of the stator manufactured according to the first embodiment. FIGS. 27 and 28 also do not show the crossover lines 4132 for simplification. In this embodiment, the preliminary formation and insertion steps are performed while axially pressing the tops of the both coil ends of the element coils 4131 by the press jigs 23; therefore, as is apparent from FIG. 28, the width β between adjacent coil ends each being inclined relative to the axis of the stator core 412 is made smaller than the width α between adjacent straight sides 4131 of the element coils 4133. Thus, this embodiment can reduce the axial height of the coil end portions.

FIG. 29 is a schematic illustration showing a front cross-sectional view of the stator manufactured according to the first embodiment. The length of the support lid 416 is approximately the same as the axial length of the stator core 412. In addition, the support lid 416 has a substantially trapezoidal cross section in which the inner periphery side is the shorter of the parallel sides. As shown in FIG. 29, each receiving groove 417 is formed to conform to the support lid 416 and therefore has a large contact area therewith, thus making the support lid 416 more resistant to a centripetal force.

Then, at the step 120 of FIG. 14 flow chart, the stator coils 413 are connected to each other in such a manner as described in FIGS. 4 and 12 via four separate crossover wires 4132a by welding, e.g., TIG welding. This operation is a connection step. The separate crossover wires 4132a are also extended between the outer and inner peripheries of the stator core 412, and all the crossover lines 4132 and crossover wires 4132a are wound in a substantially spiral overall arrangement, as shown in FIG. 10.

This is the completion of the formation of the stator 4. Further, in order to assemble a rotary electric machine, as shown in the step 121 of FIG. 14 flow chart, the stator 4 is fixed in a housing 1 equipped with necessary components and then a rotor 5 is inserted in the stator 4 to be rotatably supported by ball bearings 7a and 7b (see FIGS. 1 and 3). This is an assembly step of a rotary electric machine.

The functions and advantages of the above-described first embodiment will now be described.

With the manufacturing method according to this embodiment, continuously wound stator coils are inserted in the slots: therefore, connection points which require electrically connecting works can be reduced, thereby improving productivity of the stator windings. The above-mentioned element coils comprising the stator coil may be wound one turn or more. Since a multi-turn winding is more effective, this embodiment winds each element coil multiple turns through a pair of slots. As described above, even when the element coil is wound one turn, the total connection points of stator windings which require connecting work can be similarly reduced.

The manufacturing method of a rotary electric machine according to the first embodiment is characterized by including: a preforming step of forming a continuous insulated conductor into a stator coil comprising multiple element coils, each being spirally wound multiple turns and having a pair of straight sides; a positioning step of circumferentially disposing the preformed multiple element coils such that the two straight sides of each element coil are respectively positioned at an inner slot of a stator core and an outer groove of an inner jig; a preliminary formation step of rotating the inner straight sides of the element coils relative to the outer straight sides; an insertion step of inserting the outer and inner straight sides of the preformed element coils in the bottom and opening sides of the slots respectively; a connection step of connecting the ends of multiple stator coils to one another on the basis of a required function; and an assembly step of assembling a rotor in the thus manufactured stator such that it can be rotatably supported by bearings. With the above method, the connection points do not increase irrespective of the number of winding turns of each element coil; thereby, coils can be readily wound around a stator core with a small number of connection points. Therefore, there can be achieved reduction of the number of connection and insulation work as well as reliability and strength improvement. In addition, all the coil ends are wound to be extended between the outer periphery side of one slot and the inner periphery side of another slot in such a manner that they never cross one another; therefore, the axial height of the coil end portions can be reduced, which in turn reduces the axial length of a rotary electric machine. This also improves coolability of the coil. Furthermore, since each element coil is wound multiple turns using a continuous wire, the number of windings in each slot can easily increase, thus reducing loss due to harmonic. Moreover, the stator coils can be readily mounted in a stator core, thus enabling automated high-volume manufacturing.

In the preliminary formation step of the first embodiment manufacturing method of a rotary electric machine, before rotating the inner straight sides of the element coils relative to the outer straight sides, support jigs are fitted to both ends of the outer straight sides in order to hold the straight sides such that both ends thereof extend from both axial ends of the slots. This can prevent, in the insertion operation, the curved portion of the element coils from being caught by the tip of the teeth; therefore, the straight sides can be readily inserted in the slots.

Additionally, in the preliminary formation step, the outer straight side of each element coil and the inner straight side of another element coil are respectively positioned on the outer and inner periphery sides of a slot along the same radius. This facilitates the insertion of the straight side into the slot. Further, the coil windings can be stacked in a slot to be aligned in the radial direction, thus enhancing the space factor of the coil windings in the slot. In particular, this embodiment use a coil conductor of a substantially rectangular cross section, and therefore the space factor can increase further. This can, in turn, provide a rotary electric machine having high output power and excellent rotational properties.

In the preforming step of the first embodiment, a stator coil is formed of a continuous wire in such a manner that several pairs of element coils are continuous with each other via crossover lines. Therefore, element coils of each winding phase can be efficiently arranged and the number of connection points can also be minimized.

Further, in the preforming step of the first embodiment manufacturing method, the crossover lines are provided on only one-sided coil end portion. This can reduce the axial length of the stator compared to the case where the crossover lines are provided on both coil end portions.

Furthermore, in the preforming step, the crossover lines are configured to be spirally extended between the outer and inner periphery sides of the stator core. This minimizes the number of over striding points of the crossover lines in the coil end portion, and therefore the axial length of the stator can be reduced.

Also, in the preforming step, all the crossover lines are configured to axially project to approximately the same height above the end face of the stator core. Hence, the axial length of the stator can be further reduced.

In the first embodiment manufacturing method, all the element coils are collectively preformed by firstly positioning the outer straight sides of the element coils in slots at the positioning step, and then rotating, by means of an inner jig, the inner straight sides thereof relative to the outer straight sides at the preliminary formation step. Thus, there is no need of, for example, removing a separately preformed coil from a forming apparatus and thereafter repositioning it in a stator core. Such a feature can improve ease of manufacturing, and also can shorten the manufacturing time.

Also, prior to the preliminary formation step of the first embodiment manufacturing method, a tooth support jig is inserted between the bottom of each slot and the element coil inserted therein. During the preliminary formation step, the tooth receives a force tending to circumferentially collapse it; however, the tooth support jigs inserted in all the slots suppress such collapse of the teeth. That is, even when a circumferential force is applied to the coils, the teeth can be prevented from being collapsed.

In the first embodiment, the inner jig has outer grooves facing the slots one to one and therefore having the same number as that of the slots, where each groove has, at its bottom, a pushing member that can be radially projected and retracted. And, the insertion step is performed by pushing out the pushing members. Therefore, the inner jig can be left in place in the stator core during the preliminary formation step through the insertion step. Thus, this embodiment can minimize the number of insertion and removal operations of jigs, thereby reducing the number of assembly operations.

After the insertion step and before the connection step, support lids having an insulating function are fixed to the coil insertion openings of the slots. This prevents the coil from ejecting out of the slot due to an electromagnetic force between the stator and rotor.

The preliminary formation and insertion steps are performed while pressing the coil ends extending between both straight sides (coil end portions) of the element coils. This can distribute stress exerted on the element coils during the preliminary formation and insertion steps, thus facilitating the deformation and also preventing damage of an insulating coating such as varnish applied on the surface of the coil conductors. Additionally, the height of the coil end portions can be reduced directly.

Also, the preforming step forms a stator coil using a continuous wire such that each pair of element coils are adjacent to each other and are inserted in adjacent slots. Therefore, the number of slots can be increased as compared to a case where each pair of element coils is inserted in the same slot. As a result, the magnetomotive force waveform combining those of the three phases can be smoothed, thus reducing torque ripple and noise. Also, the increased number of slots can reduce eddy current loss due to harmonic. Further, the element coils are circumferentially disposed in such a manner as not to interfere with each other, thus providing improved coolability.

The preforming step may form both coil ends extending between both straight sides of the element coils in a substantially P-shape, and then the positioning step preferably places the element coils in such a manner that the projecting side of the P-shaped coil ends faces toward the outer periphery side of the stator core. This prevents the element coils (comprising the stator windings) from projecting toward the inner periphery side and from interfering with insertion of a rotor in the assembly step. Alternatively, both coil ends of the element coils may be formed in a substantially square-bracket shape, and then in the positioning step, the element coils may be placed in a manner such that the projecting side of the coil ends faces toward the outer periphery side of the stator, thereby more securely preventing inward projection of the coils.

In addition, the first embodiment integrally bonds adjacent coil conductors to each other after the completion of the preforming step. This prevents the coil conductors from separating from one another, thereby facilitating the insertion of the coil conductors in the slots. Further, because of the integrally binding of the coil conductors, the preliminary formation step collectively deform the multiple turns of each preformed element coil into a substantially hexagonal shape, thus improving formability of the coils.

The coil conductor used in the first embodiment rotary electric machine has a substantially rectangular cross section whose circumferential length is longer and whose radial length is shorter. This can maximize the number of turns of a coil in a slot, and also can more effectively reduce loss due to harmonic. Also, this embodiment firstly winds each coil multiple turns using a lap winding and then forms them into a desired shape; therefore, a stator coil can be readily formed without any effort.

The first embodiment employs an open-slot stator in which the width of the coil insertion opening of the slot is equal to or somewhat wider than the slot width on the bottom side, and therefore a coil can be readily inserted into a slot.

### Second Embodiment of the Invention

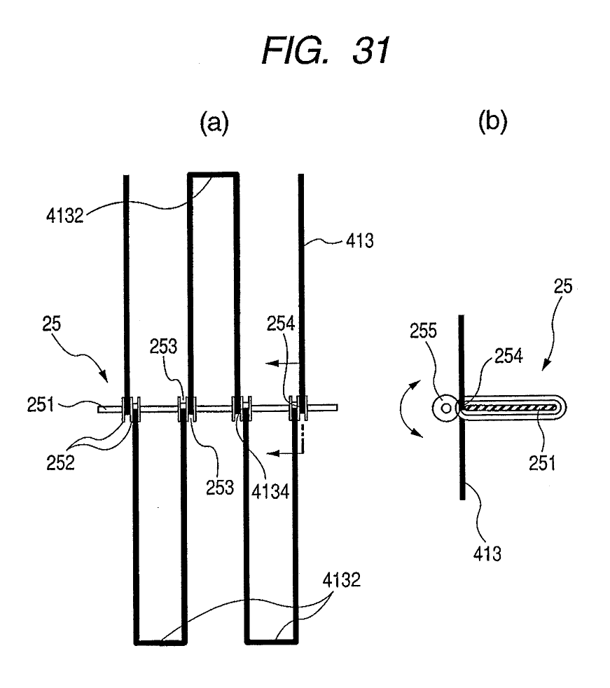

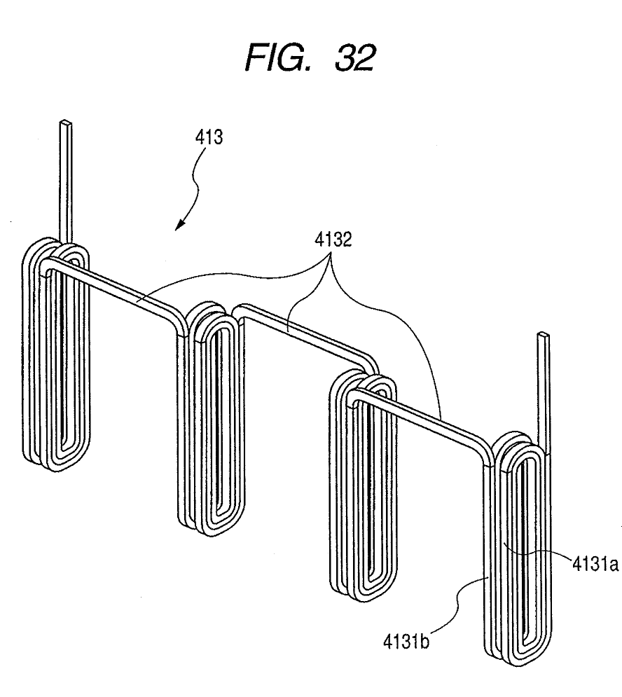

A manufacturing method of a rotary electric machine according to a second embodiment of the present invention will now be described with reference to FIGS. 30-32. FIG. 30 is a simplified schematic illustration for explaining a manner in which a pair of element coils is wound according to the second embodiment. FIGS. 31(a) and 31(b) are schematic illustrations for explaining a preforming method of a stator coil, according to the second embodiment. Here, FIG. 31(a) is a top view in which the preforming operation is performed, while FIG. 31(b) is an illustration viewed from the direction of arrow A in FIG. 31(a). FIG. 32 is a schematic illustration showing a perspective view of a stator coil formed by using the preforming method of the second embodiment. Parts identical to those of the first embodiment are indicated by the same names and the same reference numerals.

The first and second embodiments differ in the manner in which a pair of element coils 4131a and 4131b of the stator coil 413 are spirally wound in the preforming step; however, the other steps are similar therebetween and therefore the descriptions thereof will be omitted. In the first embodiment, a coil conductor is spirally wound from the innermost turn to the outermost turn of a first element coil 4131a, and then the resulting wire end extending from the outermost turn is introduced to the innermost turn of a second element coil 4131b where it is spirally wound from the innermost turn to the outermost turn. That is, the inter-element-coil connection wire 4134 (for connecting the first and second element coils 4131a and 4131b to each other) extends from the outermost turn of the element coil 4131a to the innermost turn of the second element coil 4131b, and therefore some portions of the wound wire cross each other.

On the contrary, in the second embodiment as shown in FIG. 30, a coil conductor is spirally wound from the outermost turn to the innermost turn of a first element coil 4131a, and then the wire end extending from the innermost turn is introduced to the innermost turn of a second element coil 4131b where it is spirally wound from the innermost turn to the outermost turn. That is, the inter-element-coil connection wire 4134 (for connecting the first and second element coils 4131a and 4131b to each other) extends between the innermost turns of the two element coils, and therefore there are no portions of the wound wire that cross each other. This winding is generally called an α-winding. Use of such a winding can further simplify the structure of the coil end and reduce the axial length of the stator 4. FIG. 30 shows only a pair of element coils 4131a and 4131b, but actually a stator coil including four pairs of element coils is formed of a single continuous conductor as shown in FIG. 32.

Next, the preforming step of forming such a pair of element coils of an α-winding will be described.

The preforming step of the second embodiment firstly forms a continuous conductor into a substantially projection-and-depression (meander) shape as shown in FIG. 31(a). Here, the length between the top of the projection and bottom of the depression (the total height in FIG. 31(a)) is the total conductor length required for winding a pair of element coils 4131a and 4131b, while the top width of the projection and the bottom width of the depression (the length of the side 4132 in FIG. 31(a)) is the same as that of the crossover line 4132. Further, at the middle between the top of the projection and bottom of the depression, the conductor is laterally extended in an amount corresponding to the conductor width by bending it twice in a crank-shape manner, thereby forming the inter-element-coil connection 4134.

Then, the meander-shaped conductor is fitted on an α-winding jig 25 having shaping grooves around its oval outer periphery. The α-winding jig 25 is made of a core plate 251 having a plurality of shaping grooves 253 formed thereon, and on the core plate 251 can be fitted a plurality of detachable partitions 252 for separating adjacent shaping grooves 253. Along the length of the core plate 251, four pairs of adjacent shaping grooves 253 are equally spaced with a spacing corresponding to the length of the crossover line 4132. The partition 252 for separating a pair of adjacent shaping grooves 253 from each other is provided with a communication cutout 254 through which one conductor can pass. The communication cutout 254 is provided at one end of the major axis of the oval cross section of the plate 251. Although not detailed here, the core plate 251 can expand and contract by a similar manner such as the core plate 14 in the first embodiment.

The inter-element-coil connection 4134 of the conductor is passed through each communication cutout 254 of thus configured α-winding jig 25. FIG. 31 illustrates the inter-element-coil connections 4134 passed through the communication cutouts 254.

Then, the conductor is wound around the shaping grooves 253 by means of rollers 253 (provided at the grooves as shown in FIG. 31(b)) while being pressed against the shaping grooves 253, thereby forming the element coils. Here, the two rollers 255 respectively provided at a pair of adjacent shaping grooves 253 are rotated in opposite directions.

Then, all the partitions 253 between the adjacent shaping grooves are removed and thereafter the shaped coil is removed from the α-winding jig 25 while contracting the core plate 251. Thus, a stator coil as shown in FIG. 32 is formed. Then, procedures similar to the step 112 of the first embodiment are performed, thereby completing the preforming step. The steps other than the preforming step are performed similarly to the first embodiment.

As described above, the manufacturing method of a rotary electric machine according to the second embodiment continuously connects the innermost turns of each pair of element coils to each other at the preforming step. This can prevent portions of the wound conductor from crossing each other. Therefore, the coil end structure can be further simplified, leading to reduction in the axial length of stator windings.

In the second embodiment, the crossover lines are extended between the outer periphery sides of two element coils, and therefore never cross the coil ends of the element coils. As a result, the axial length of the stator windings can be reduced.

As described above, the preforming step of the second embodiment preforms a coil conductor in a projection-and-depression (meander) shape and then winds the projecting and depressing portions around a shaping jig. Hence, pairs of element coils can be readily formed, facilitating automated manufacturing.

### Third Embodiment of the Invention

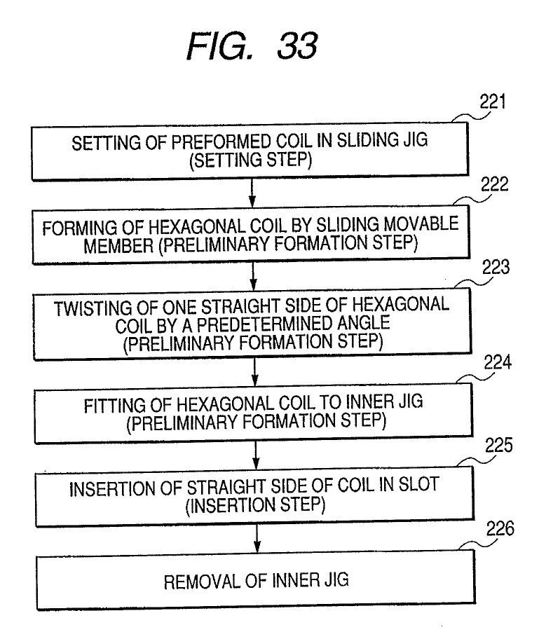

Next, a manufacturing method of a rotary electric machine according to a third embodiment of the present invention will be described with reference to FIGS. 33-41. Parts common to the other aforementioned embodiments are indicated by the same names and the same reference numerals.

This embodiment differs from the second embodiment in the positioning step through the insertion step, but the other steps are similar therebetween. Therefore, only the positioning step through the insertion step of this embodiment will be described.

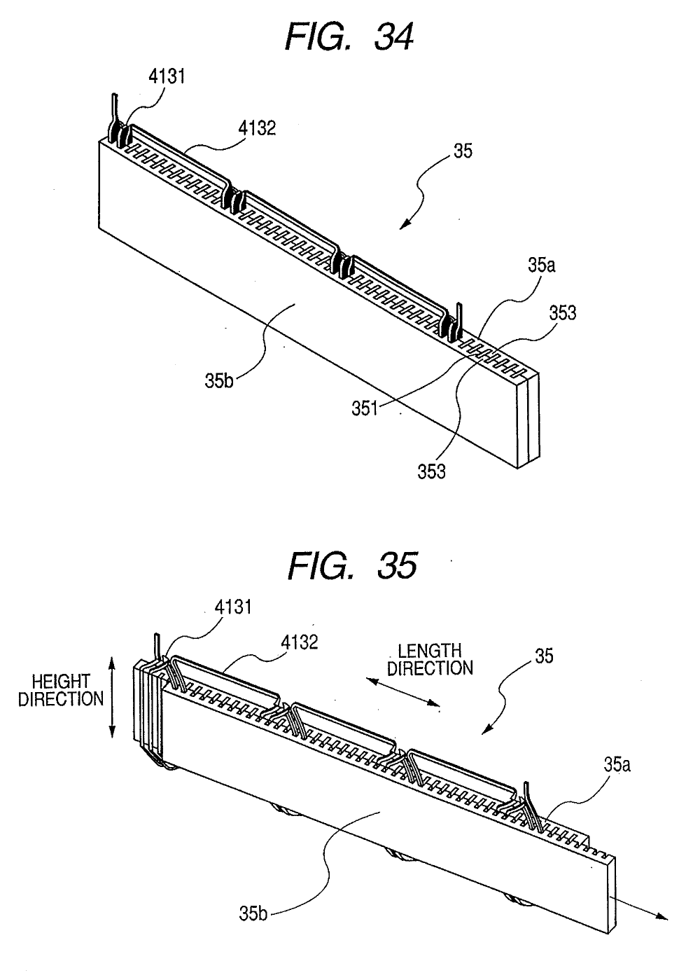

FIG. 33 is a manufacturing flow chart for explaining a positioning step through an insertion step, which is a feature of the third embodiment. FIG. 34 is a schematic illustration showing a perspective view of a preformed coil fitted in a slide jig used in the third embodiment. FIG. 35 is a schematic illustration showing a perspective view in which the slide jig is slid to form element coils in a substantially hexagonal shape. This embodiment performs the preforming step similarly to the second embodiment, and then fits the preformed coil in a slide jig 35 as indicated by the step 221 of FIG. 33 flow chart and as shown in FIG. 34. This is the setting step. The slide jig 35 includes an immovable member 35a and a movable member 35b each being substantially plate-like in shape, and the movable member 35b is movable relative to the immovable member 35a along its length direction, as shown in FIG. 35.

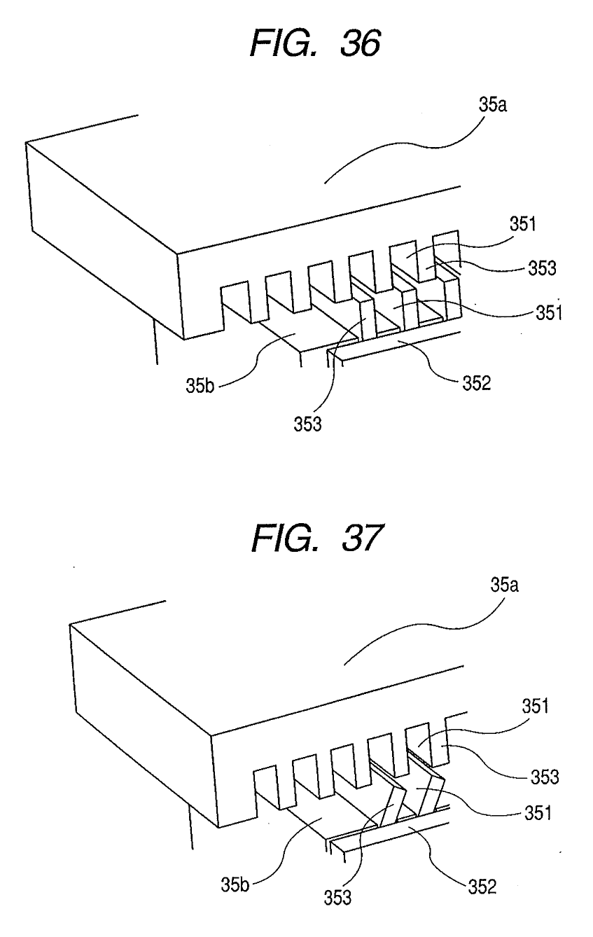

Further, the movable member 35b is moved through a guide 352 as shown in FIGS. 36 and 37. FIG. 36 is a schematic illustration showing an enlarged perspective view of some of holding grooves of the slide jig; and FIG. 37 is a schematic illustration showing an enlarged perspective view in which the holding grooves of one of two slide members of the slide jig in FIG. 36 are inclined.

On each of the facing surfaces of the immovable member 35a and movable member 35b, holding grooves 351 of the same number as that of the slots 411 of the stator core 412 are equally spaced in parallel along the length direction, in which each holding groove 351 extends along the height direction and is longer than the slot 411. Further, partition walls 353 defining holding grooves 351 are configured to be laterally tiltable. That is, the partition walls 363 which originally stand vertical to the base of the movable member 35b as shown in FIG. 36 can tilt in such a manner as shown in FIG. 37. Although such a tilting mechanism is not described in detail herein, all the partition walls 353 can be tilted together coherently by employing a link or cam mechanism, etc.

Thus configured slide jig 35 is set such that all the holding grooves 351 of the immovable member 35a face the corresponding holding grooves 351 of the movable member 35b one to one, and then the element coils 4131 of a preformed coil are inserted in the corresponding pairs of the holding grooves 351 in the height direction of the slide jig 35. While, for easy understanding, FIG. 34 shows that four pairs of element coils 4131 composing a continuous stator coil are inserted in the corresponding holding grooves 3151, actually all the element coils 4131 are inserted in all the holding grooves 3151.

Then at the step 222, the movable member 35b is slid relative to the immovable member 35a in the length direction, thereby deforming the element coils 4131 in a substantially hexagonal shape. While FIG. 35 shows a mid course of such a sliding operation, the movable member 35b is slid to a final position that is five holding grooves 315 apart from the start position of FIG. 34. Although not shown, the above sliding operation is performed while pressing the coil ends of the element coils 4131 inwardly in the height direction similarly to the first embodiment, thereby allowing the element coils 4131 to be readily deformed in a substantially hexagonal shape.

Then at the step 223, the straight sides of the substantially hexagonal-shape element coils 4133 inserted in the movable member 35b are twisted by a predetermined rotation angle by means of the partition walls 353. Specifically, the twisting operation is performed by simultaneously tilting all the partition walls 353 of the movable member 35b together as shown in FIG. 37. Since the stator coil 413 is wound using a flat conductor having a substantially rectangular cross section, tilting the partition walls 353 cause the straight side (inserted in the movable member 35b) of the element coils 4133 to be twisted (rotated) by the tilting angle. The angle to be inclined is chosen such that the straight side (inserted in the immovable member 35a) of an element coil 4133 and the straight side (inserted in the movable member 35b) of another element coil 4133 are oriented in the same radial direction when a set of stator coils are formed in a circle in the succeeding step. In the flow chart of FIG. 33, the preforming procedure includes the steps 222 to 224. And, the twisting operation of the step 223 may be carried out during the sliding operation of the step 222.

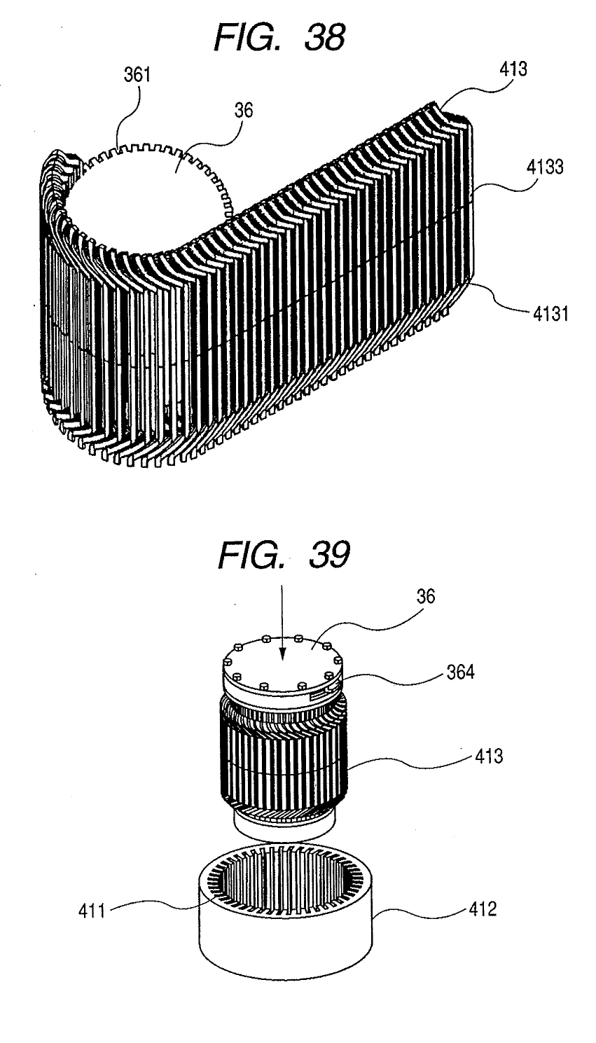

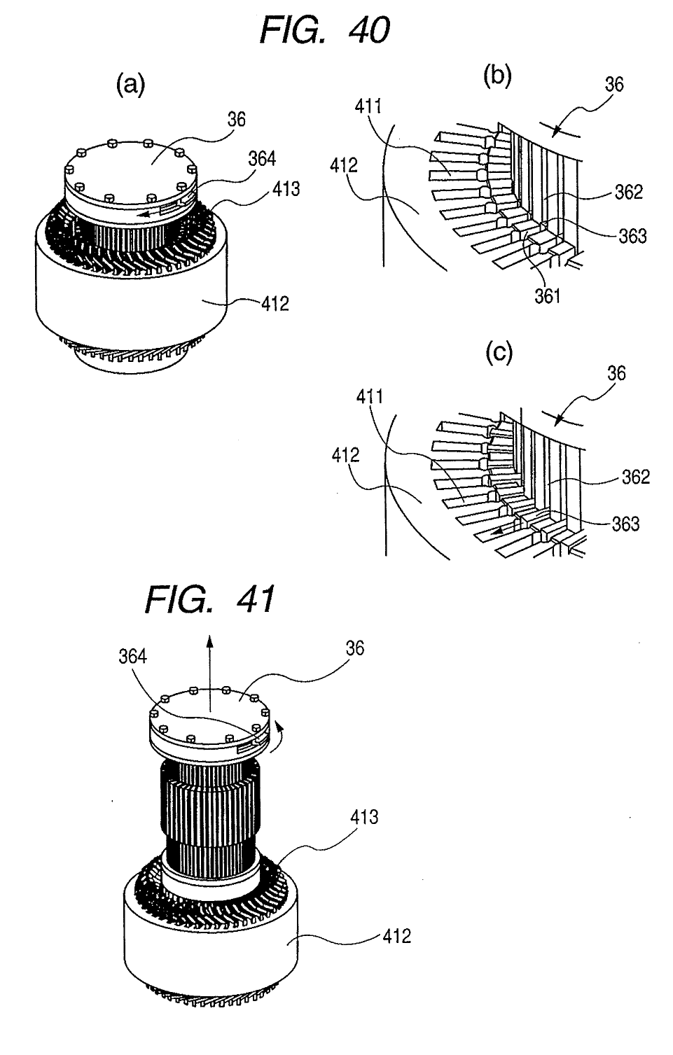

Then at the step 224, a set of stator coils including the hexagonally preformed element coils 4131 are fitted around an inner jig 36 as shown in FIG. 38. FIG. 38 is a schematic illustration showing a perspective view in which a set of stator coils each including substantially hexagonal shaped element coils is wound around an inner jig, according to the third embodiment. Similarly to the inner jig 19 of the first embodiment, the inner jig 36 has, on its outer periphery, outer grooves 361 of the same number as the slots 411 of the stator core 412, and the circumferential width of the outer groove 361 is somewhat smaller than or equal to that of the opening of the slot 411. While, the axial length thereof is longer than that of the slot 411. Further, at the bottom of each outer groove 361 there is formed a slit 362, as shown in FIGS. 40(b) and 40(c). FIGS. 40(a) to 40(c) are schematic illustrations showing perspective views in which an insertion step is performed according to the third embodiment. Here, FIG. 40(a) is an overall view, while FIGS. 40(b) and 40(c) are perspective views in which pushing members of the inner jig are retracted and projected, respectively. The insertion step will be described later. A plate-like pushing member 363 is provided to be radially projectable and retractable through the slit 362. Although not described in detail, the pushing members 363 can be radially projected and retracted through the slits 362 by swinging a lever 364 provided at an axial end of the inner jig 364.

The stator coils are placed around thus configured inner jig 36 in such a manner that the straight sides 4133 of the element coils 4131 are inserted in the corresponding outer grooves 361 (see FIG. 38). Here, in the outer grooves 361 there are inserted together the paired element coil straight sides 4133 respectively inserted in the immovable member 35a and movable member 35b. However, the last five unpaired straight sides 4133 are inserted in the grooves 361, after one turn, over the first five unpaired straight sides 4133. As described above, the straight sides of the element coils 4133 inserted in the movable member 35b have been deformed to have a predetermined twist angle at the step 223. Therefore, each pair of facing straight sides 4133 can be overlapped to be oriented in the same radial direction when the set of stator coils are wound around the inner jig 36. This is the completion of the preforming step. For easy understanding, FIG. 38 does not show the detailed structure of the inner jig 36 or the crossover lines 4132.

Then, at the step 225, the straight sides 4133 of the element coils are inserted in the slots of the stator core 412. This is the insertion step. FIG. 39 is a schematic illustration showing a perspective view in which the inner jig fitted with a set of stator coils is being inserted into the bore of a stator core, according to the third embodiment. As shown in FIG. 39, the inner jig 36 around which the set of stator coils 413 are wound at the preforming step is inserted in the bore of the stator core 412. Unlike the first embodiment, each slot 411 of this embodiment is inclined relative to a radius of the stator core 412. This facilitates the insertion of the annularly preformed stator coils 413 into the slots. Also for simplification, FIG. 39 does not show the crossover lines 4132.

Then, the lever 364 of the inner jig 36 is swung as shown in FIG. 40(a). As described above, swinging the lever 364 can switch between two states in which the pushing members 363 are respectively retracted (FIG. 40(b)) and projected (FIG. 40(c)) from the slits 362. For example, swinging the lever 364 in the direction of the arrow shown in FIG. 40(a) causes the pushing members 363 to project from the slits 362 as shown in FIG. 40(c), which, in turn, push out the paired straight sides of the element coils 4133 into the slots 411 of the stator core 412. After a set of the stator coils 413 has been inserted in the slots 411 in this way, the lever 364 is swung in the direction of the arrow shown in FIG. 41 in order to retract the pushing members 363 from the slits 362 and then the inner jig 36 is removed out of the bore of the stator core 412. FIG. 41 is a schematic illustration showing a perspective view in which the inner jig is being removed according to a third embodiment. Thereafter, the connection and assembly steps similar to those of the first embodiment are carried out. For clarity's sake, FIGS. 40 and 41 also do not show the crossover lines 4132.

The above-described manufacturing method of a rotary electric machine according to the third embodiment includes: a preforming step of preforming a continuous wire into a stator coil comprising multiple element coils, each being spirally wound multiple turns and having a pair of opposing straight sides; a setting step of inserting a set of a plurality of the stator coils in two different shaping molds such that both straight sides of each element coil are parallely inserted into a pair of facing holding grooves, which are respectively provided in the two different shaping molds; a preliminary formation step of shaping each element coil by sliding at least one of the shaping molds relative to the other and thereafter forming the set of the stator coils into a circle in such a manner that one longitudinal end thereof is laid over the other end; an insertion step of inserting the straight side of the preliminary formed element coils positioned at the outer side of the circle into the bottom side of the slots and inserting the straight side thereof positioned at the inner side of the circle into the insertion opening side of the slots; a connection step of connecting ends of the plurality of the stator coils to each other on the basis of a required function; and an assembly step of rotatably mounting a rotor in the stator by means of a bearing. Thus, this embodiment has an advantage of preventing application of force to the teeth of a stator core in the manufacturing steps in addition to the aforementioned functions and advantages of the first embodiment. This allows insertion of a continuous lap wound coil in the slots of a stator core, even if the tooth has a small width (thickness) and is prone to collapse.

In addition, the coils of the third embodiment are also wound of a flat conductor having a substantially rectangular cross section. The holding grooves of at least one shaping mold are configured to be deformable, and therefore the coil conductors inserted therein (slot portion) can be deformed together with the deformable holding grooves at the preliminary formation step. As a result, when a set of stator coils is wound in a circle, each pair of element coil straight sides respectively positioned at the outer and inner sides of the circle can be readily overlapped each other (i.e., each conductor of the overlapped straight sides of the element coils is arranged in a line), thereby facilitating the insertion operation at the succeeding insertion step.

Further, in the preliminary formation step of the third embodiment, a set of stator coils is formed in a circle by inserting the pairs of element coil straight sides into a plurality of the outer grooves of the inner jig. Thus, the set of stator coils can be conformed to the inner periphery of a stator core, also facilitating the insertion operation at the succeeding insertion step.

Furthermore, in the third embodiment, the inner jig has the pushing members that can be radially projected and retracted from the bottoms of the outer grooves, and the insertion step is performed by projecting the pushing members. This can reduce the number of jigs and can also minimize the number of insertion and removal operations of jigs in and out of a stator core.

While the manufacturing methods of a rotary electric machine according to the embodiments of the invention have been described, other embodiments of a coil and rotor will now be described.

### Fourth Embodiment of the Invention

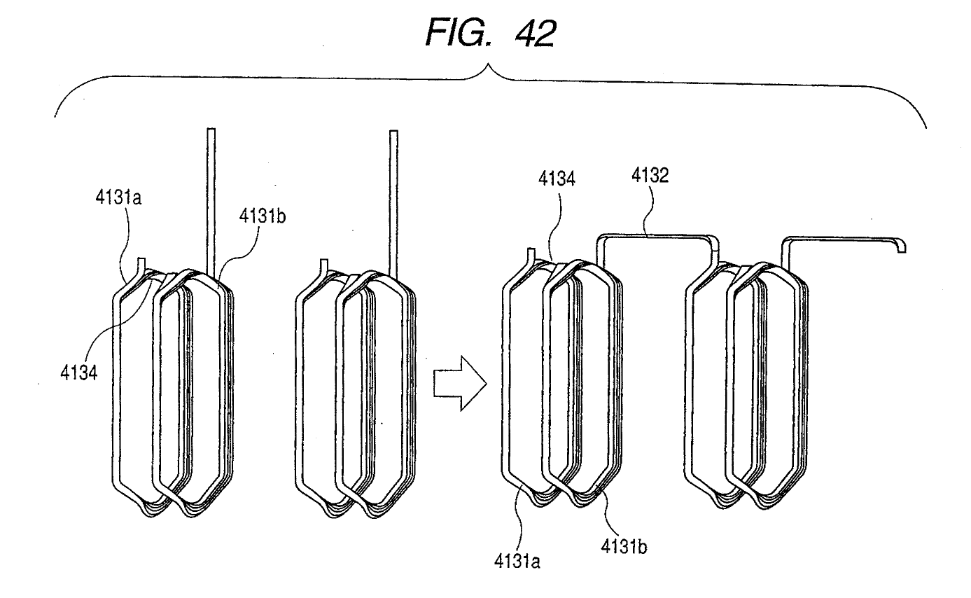

A fourth embodiment will be described with reference to FIG. 42. FIG. 42 is a schematic illustration showing a perspective view in which neighboring pairs of element coils 4131a and 4131b are connected to each other via a crossover wire, according to the fourth embodiment. Parts common to the other aforementioned embodiments are indicated by the same names and the same reference numerals.

In the first embodiment, the stator coil 413 including four pairs of element coils (4131a and 4131b) is wound of a single continuous conductor. On the contrary, in the fourth embodiment, each of the four pairs of element coils (4131a and 4131b) is separately wound and then the four pairs are connected, e.g., by welding, thus obtaining a stator coil 413. More specifically, one end of a pair of element coils (4131a and 4131b) is extended in an amount corresponding to the length of the crossover line 4132, and, after the pair of element coils is inserted in the slots of a stator core 412, the extension thereof is deformed and connected to another pair of element coils by welding or the like.

With such a method in which the crossover lines 4132 are separately connected in a later manufacturing step, no consideration is required as to deformation of the crossover lines 4132 when inserting the preformed coils into the slots 411 of the stator core 412 while radially expanding them. This can enhance flexibility in the arrangement of the crossover lines 4132 although it involves some increase in the number of connection points required. In addition, since the crossover line 4132 is formed of the extension from one end of a pair of element coils 4131, the number of parts and connection points can be reduced as compared to a case where the crossover line is formed of a separate wire. It is added that a pair of element coils shown in FIG. 42 is wound by the α-winding method described in the second embodiment.

### Fifth Embodiment of the Invention

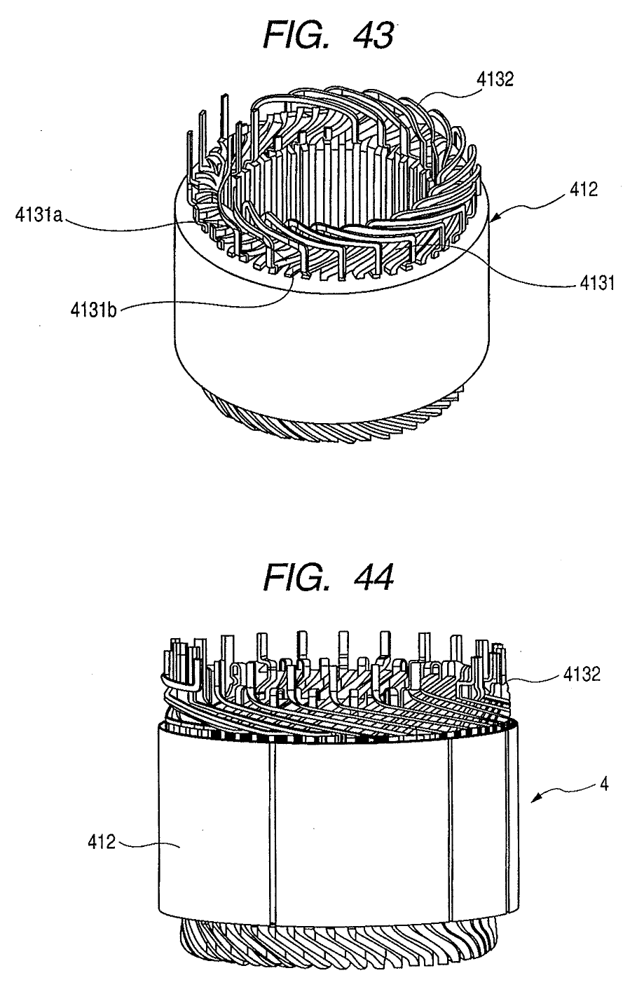

Next, a fifth embodiment of the present invention will be described with reference to FIG. 43. FIG. 43 is a schematic illustration showing a perspective view of a stator manufactured according to the fifth embodiment. Parts common to the other aforementioned embodiments are indicated by the same names and the same reference numerals.

The fifth embodiment differs from the first embodiment in the manner in which the crossover lines 4132 are connected and employs an α-winding method for winding a pair of element coils (4131a and 4131b) similarly to the second embodiment. The other configurations are the same as the first and second embodiments. In the first embodiment, the crossover line 4132 is extended between the tops of the coil ends of two element coils 4131. On the contrary, in the fifth embodiment, the crossover line 4132 is extended between the feet (a portion near the axial end of a slot) of the coil ends of two element coils 4131. More specifically, a crossover line 4132 is wound as follows. From the foot of a first coil end on the bottom side of a slot 411, the crossover line 4132 is first bent step-wise toward the outer periphery and then is extended back toward the inner periphery. And, from the foot of a second coil end on the insertion opening side of a slot 411, the crossover line 4132 is first bent step-wise toward the inner periphery and then is extended back toward the outer periphery where it meets the crossover line 4132 extending from the foot of the first coil end. Similarly to the first embodiment, all the crossover lines are arranged in a substantially spiral form as viewed in the axial direction of the stator. For easy understanding, FIG. 43 does not show the crossover line for connecting the neutral points to each other or the inter-element-coil connections each continuously extending between a pair of element coils.

In the fifth embodiment, the crossover lines 4132 are not extended between the tops of coil ends as described above, thereby enabling a further reduction in the axial length of the stator 4 (stator windings 40). In addition, the crossover lines are disposed in such a manner that the longer side of the cross section of a flat conductor used for the winding is oriented in the axial direction of the stator 4; therefore, crossover lines can be arranged with less difficulty even around a stator core 412 having a small diameter.

It is noted that the crossover line 4132 of the fifth embodiment is not extended from the top of a coil end but from the foot thereof (a portion near the axial end of a slot), and therefore the length of the preformed crossover line may change when preforming the element coils 4131 in a substantially hexagonal shape. In order to address this problem, as has been described in the first embodiment, the crossover lines 4132 are bent in a substantially V or U shape such that they bulge in axial and/or radial directions before forming the element coils 4131 in a substantially hexagonal shape. Thereafter, the crossover lines 4132 thus bent are straightened when inserting the preformed coils into the slots 411 of the stator core 412. In addition, a method for winding a pair of the element coils 4131a and 4131b is not limited to the one described in FIG. 30 but may be the one described in the first embodiment.

### Sixth Embodiment of the Invention

Next, a sixth embodiment of the present invention will be described with reference to FIG. 44. FIG. 44 is a schematic illustration showing a perspective view of a stator manufactured according to the sixth embodiment. Parts common to the other aforementioned embodiments are indicated by the same names and the same reference numerals.

The sixth embodiment differs from the fifth embodiment in the form and arrangement of the crossover lines 4132, but the others are similar therebetween. In the sixth embodiment, the crossover lines 4132 are not arranged in a spiral form as viewed in the axial direction, but connect two element coils 4131 to each other on the bottom side of the slot 411 (or the outer periphery side of the stator core 412) in a helical manner. FIG. 44 shows a view before the coils are welded to each other. End portions of the conductors seem to project in the axial direction of the stator 4 as shown in FIG. 44. However, the end portions of conductors projecting in the axial direction of the stator 4 are melt-connected to each other, e.g., by TIG welding, actually melt and retract to a position just above the coil end.

In this way, the sixth embodiment can arrange the crossover lines 4132 without causing them to axially project above the tops of the coil ends too much, and can therefore further reduce the axial length of the stator 4 compared to the fifth embodiment. In addition, the crossover lines 4132 and the element coils 4131 can be formed of a single continuous conductor by devising a forming method. Further, the crossover lines 4132 may be helically connected between two pairs of element coils on the coil insertion sides of the slots (the inner periphery sides of the stator core 412), or on both the inner and outer periphery sides of the stator core 412.

### Other Embodiments of the Invention

While the configurations, functions and advantages of the embodiments of the invention have been described; various other configurations may be employed. The cross section of the flat conductor used for winding the coil is substantially rectangular in the aforementioned embodiments, but may not necessarily be rectangular; for example, the sides of the wire may be curved like the shape of a flat conductor after being inserted and deformed in a slot. Also, there may be used a coil conductor having a substantially circular, substantially oval or substantially polygonal cross section. In the case of a rectangular cross section conductor, the cross section may be a substantial square, or a substantially rectangle which, when inserted in a slot, has longer sides in the radial direction of a stator core and having shorter side in the circumferential direction.

While the above embodiments have been described using an induction motor as an example of a rotary electric machine, the present invention can be also applied to other types of rotary electric machines such as a permanent magnet synchronous motor in which a rotor has circumferentially disposed permanent magnets. A rotor used in such a permanent magnet synchronous motor includes: a surface magnet rotor which has on its surface a plurality of magnets secured by a non-magnetic ring or the like; and an interior magnet rotor which has magnets embedded in a plurality of axially extending holes formed within the rotor. Further, when the present invention is applied to a vehicle-use AC generator, there can be used a Lundell rotor having a field coil winding therewithin.

While the stator and rotor magnetic cores of the aforementioned embodiments are formed of laminated steel plates, there may be used a powder magnetic core formed by compressing iron powder particles having an insulating coating applied to the surface thereof. In addition, the stator core may be assembled from a plurality of stator core segments. While the conductor bar and short-circuiting ring of the aforementioned embodiments are made of aluminum, copper may also be used. Use of copper for the conductor bar and short-circuiting ring can reduce electrical resistance compared to aluminum, thus improving efficiency of a rotary electric motor.

While the number of the slots of the stator core is 48, it may be changed according to specification. In this case, the arrangement of the element coils needs to be changed accordingly. In the aforementioned embodiments, the number of the element coils that are continuously wound and are adjacent to each other is two, but it is not limited to two but may be, e.g., three or four. Also, the number of turns of each element coil can be chosen according to specification.

A self-bonding wire is used for bonding adjacent coil conductor portions together in the aforementioned embodiments; however, depending on configuration, there may be used other methods such as an adhesive and a tape, or the need for such bonding may be eliminated. In the aforementioned embodiments, the insulating paper is first placed in the slots before inserting the coils in the slots, but the coils may be inserted in the slots of the stator core after bonding the insulating paper to the coils.

While, in the aforementioned embodiments, the coils in the open slots are held by the support lids provided between the tips of the teeth, the openings of the slots may be capped with a resin molding material or the like to hold the coils. In the aforementioned embodiments, the element coils are preformed in a substantially hexagonal shape and are then inserted in the stator core, but they may be preformed in a shape other than a hexagonal shape. The aforementioned embodiments employ a 2Y configuration which has a pair of parallel connected windings for each stator phase, there may also be adopted a 1Y configuration which has, for each phase, only one winding composed of serially connected multiple coils. Use of such 1Y configuration further reduces the number of connection points required.

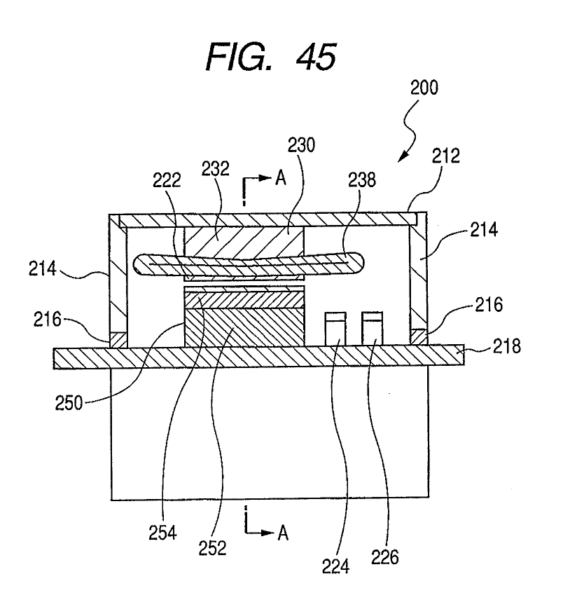

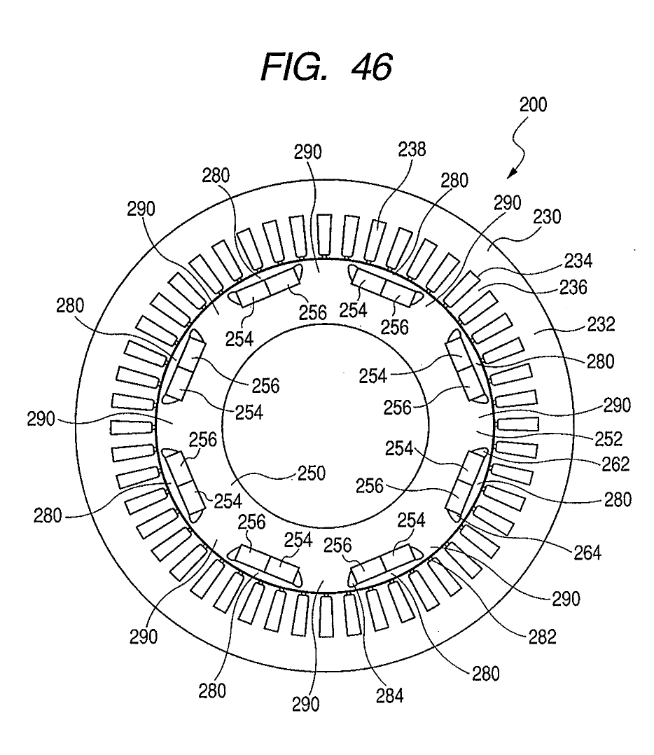

The aforementioned stator windings can be applied not only to induction motors but also to permanent magnet rotary electric machines. A permanent magnet rotary electric machine using the aforementioned stator windings will now be described with reference to FIGS. 45 and 46. FIG. 45 is a schematic illustration showing a cross sectional view of a permanent magnet rotary electric machine 200. FIG. 46 is a schematic illustration showing a cross sectional view of a stator 230 and a rotor 250 cutting along A-A line in FIG. 45. A housing 212 and a shaft 218 are not shown in FIG. 46.

As shown in FIG. 45, a housing 212 holds therewithin a stator 230 having a stator core 232 and the stator windings 238 of the present invention. A rotor 250 having permanent magnets 254 is placed inside the stator core 232 via a gap space 222. The housing 212 has an end bracket 214 at both axial ends of a shaft 218. The shaft 218 of a rotor core 252 is rotatably supported by bearings 216 provided at the respective end brackets 214. The shaft 218 is provided with a rotor position sensor 224 for detecting a position of the rotor poles and a rotation rate sensor 226 for detecting the rotation rate of the rotor. A three-phase AC supply to the stator windings is controlled on the basis of the outputs of the sensors.

A more specific structure of the stator 230 and rotor 250 of FIG. 45 is described with reference to FIG. 46. The stator 230 has the stator core 232, which has circumferentially equally spaced slots 234 and teeth 236 similarly to the structure of the aforementioned embodiments. Through the slots 234 are wound the stator coils 238 according to the method of the present invention. The number of the slots of the stator core is 48 in FIG. 46, but it is not limited to this particular number. Permanent magnets 254 and 256 are inserted in permanent magnet insertion holes provided within the rotor core 252. The permanent magnets 254 and 256 are oriented in the radial direction of the rotor, and the orientation of the magnets of each rotor pole is reversed with respect to a neighboring rotor pole.

In the embodiment of FIG. 46, a pair of the permanent magnets 254 and 256 function as a pole of the rotor 250. The poles of the rotor 250 each consisting of a pair of the permanent magnets 254 and 256 are equally spaced along the circumference of the rotor 250. This embodiment has eight poles. However, the number of poles is not limited to eight, but varies depending on the performance required for a rotary electric machine such as output power, and may be ten to thirty and in some cases more than that number. It may be less than eight depending on specification. A portion of the rotor core adjacent to each pair of permanent magnets 254 and 256 on the side of the stator functions as a pole piece 280, and lines of magnetic force passing through the permanent magnets 254 and 256 go in and out of the stator core 232 via the pole piece 280.

As described above, the orientation of the pair of the permanent magnets 254 and 256 of each pole of the rotor 250 is reversed with respect to a neighboring rotor pole. That is, when the N pole of the permanent magnets 254 and 256 of a rotor pole faces the stator, the N pole of the permanent magnets 254 and 256 of neighboring rotor poles faces the shaft. Between neighboring poles of the rotor 250 exists a portion functioning as an auxiliary pole piece 290, and a reluctance torque generates due to a difference between magnetic circuit inductances to the q-axis magnetic flux passing through the auxiliary pole piece 290 and the d-axis magnetic flux passing through the permanent magnet. There are bridge portions 282 and 284 between each pole piece 280 and respective neighboring auxiliary pole pieces 290, and the cross sections of the magnetic circuits at the bridge portions 282 and 284 are narrowed by magnetic gaps 262 and 264, respectively. This causes magnetic saturation at the bridge portions 282 and 284, and thereby magnetic fluxes passing between the pole piece 280 and respective auxiliary pole pieces 290, i.e., passing through the bridge portions 282 and 284, can be suppressed to a certain level.

In order to regulate the conversion of a DC power supply from the secondary rechargeable battery 612 to a three-phase AC power, the switching operation of the inverter in FIG. 4 is controlled on the basis of outputs from the rotation rate sensor 226 and rotor position sensor 224 provided at the rotor of the rotary electric machine in FIGS. 45 and 46. Then, the three-phase AC power is supplied to the stator coils 238 in FIGS. 45 and 46. In turn, the frequency of the three-phase AC and the phase shift thereof relative to the rotor are controlled on the basis of outputs detected at the rotation rate sensor 226 and rotor position sensor 224, respectively.

A rotating magnetic field produced by energizing the stator 230 with the three-phase AC having thus regulated phase and frequency exerts a magnetic torque to the permanent magnets 254 and 256 of the rotor 250. The rotating magnetic field is also applied to the auxiliary pole pieces 290 of the rotor 290, and a reluctance torque generates due to a difference between inductances of the magnetic circuit passing through the permanent magnets (254 and 256) and the magnetic circuit passing through the auxiliary pole piece 290. The rotational torque of the rotor 250 depends on both the permanent magnet torque exerted on the permanent magnets and the reluctance torque generated due to the auxiliary pole piece.

The reluctance torque is generated by a difference between the inductance to the rotating magnetic field produced by the stator windings of the magnetic circuit composed of the permanent magnets (254 and 256) and that of the magnetic circuit composed of the auxiliary pole piece 290. Therefore, the inverter 620 in FIG. 4 is controlled such that the rotation of the resultant magnetomotive force vector generated by the stator windings 238 leads, in the rotation direction, the rotation of the auxiliary pole piece 290 of the rotor, thereby generating a reluctance torque due to the leading phase angle of the rotating magnetic field relative to the rotation of the auxiliary pole piece 290 of the rotor.

The reluctance torque has the same direction as that of the magnet torque exerted on the permanent magnets 254 and 256, and is therefore added to the magnet torque to produce a combined rotational torque on the stator 250. Therefore, the torque required for a rotary electric machine can be controlled by means of the combined torque of the magnet and reluctance torques. That is, the magnet torque component can be reduced by an amount corresponding to the reluctance torque, and as a result the magnetomotive force required to be generated by the permanent magnets can be reduced. Reducing the magnetomotive force generated by the permanent magnets can suppress voltage induced by the permanent magnets under high rotation rate operations of a rotary electric machine, thus facilitating power supply to a rotary electric machine during high rate rotations. In addition, increasing the reluctance torque has an advantage of reducing the required amount of permanent magnet. Further, since rare earth permanent magnets are expensive, reducing the required amount of permanent magnet is also advantageous from an economical point of view.

The stator windings according to the aforementioned embodiments can be applied to induction rotary machines and permanent magnet rotary machines, and can provide rotary electric machines with excellent productivity and high reliability. In the aforementioned embodiments, each slot has only one conductor in the circumferential direction, thus offering a rotary electric machine with less torque ripple and excellent productivity. In the aforementioned embodiments, each coil having multiple turns can be wound using a continuous conductor, thus providing a rotary electric machine with a smaller number of connection points and excellent productivity.

The embodiments as described above can be summarized as follows.

(1) The present invention discloses a manufacturing method for a rotary electric machine, which includes the steps of: preforming a coil comprising a plurality of element coils of an insulated conductor; inserting a first side of a first element coil of the element coils into a first slot of a stator core through an opening of the first slot; inserting a second side of the first element coil into a second slot in which a first side of a second element coil of the element coils has been already inserted; electrically connecting coil ends of a plurality of the coils to each other; and rotatably mounting a rotor inside the stator core.

(2) The present invention discloses a manufacturing method for a rotary electric machine, which includes the steps of: preforming a coil comprising a plurality of element coils of an insulated conductor; inserting a first side of a first element coil into a first slot of a stator core through an opening of the first slot, and placing a second side of the first element coil near the inner periphery of the stator core; inserting the second side of the first element coil placed near the inner periphery of the stator core into a second slot, which is apart from the first slot by a predetermined number of slots and in which a first side of a second element coil has been already inserted; electrically connecting coil ends of a plurality of the coils to each other; and rotatably mounting a rotor inside the stator core.

(3) The present invention discloses a manufacturing method for a rotary electric machine, which includes the steps of: preforming a coil comprising a plurality of multiple turned element coils of an insulated conductor; inserting a first side of a first multi-turn element coil into a first slot of a stator core through an opening of the first slot, and laying, one above another, the multi-turn conductors on the first side of the first multi-turn element coil in the depth direction of the first slot, and further placing the second side of the first multi-turn element coil near the inner periphery of the stator core; inserting the second side of the first multi-turn element coil into a second slot, which is apart from the first slot by a predetermined number of slots and in which a first side of a second multi-turn element coil has been already inserted, and laying, one above another, the multi-turn conductors on the second side of the first multi-turn element coil in the depth direction of the second slot; electrically connecting coil ends of a plurality of the coils to each other; and rotatably mounting a rotor inside the stator core.

(4) The present invention discloses a manufacturing method for a rotary electric machine, which includes the steps of: preforming a coil comprising a plurality of multiple turned element coils of an insulated conductor in which the multi-turn element coils are connected to each other by a crossover line; inserting a first side of a first multi-turn element coil into a first slot of a stator core through an opening of the first slot, then laying, one above another, the multi-turn conductors on the first side of the first multi-turn element coil in the depth direction of the first slot, then placing the second side of the first multi-turn element coil near the inner periphery of the stator core, and further placing the crossover line on one axial end side of the stator core; inserting the second side of the first multi-turn element coil into a second slot, which is apart from the first slot by a predetermined number of slots and in which a first side of a second multi-turn element coil has been already inserted, and laying, one above another, the multi-turn conductors on the second side of the first multi-turn element coil in the depth direction of the second slot; electrically connecting coil ends of a plurality of the coils to each other; and rotatably mounting a rotor inside the stator core.

(5) The present invention discloses the manufacturing method for a rotary electric machine described in (1), (2), (3) or (4) above, in which each preformed element coil has a pair of straight sides, and the straight side of each element coil is the above-mentioned side of each element coil.

(6) The present invention discloses a manufacturing method for a rotary electric machine in which the rotary electric machine comprises: a stator including: a stator core having a plurality of circumferentially spaced slots each having a coil insertion opening on its inner periphery side, and a coil wound around the stator core through the slots; and a rotor having a plurality of circumferentially spaced magnetic poles and rotating relative to the stator, the manufacturing method including: a preforming step of forming a continuous coil including a spirally wound multi-turn element coil having a pair of opposing straight sides; a positioning step of positioning a plurality of the element coils such that opposing first and second straight sides of each element coil are respectively positioned on the inner and outer periphery sides of the stator core; a preliminary formation step of rotating the first straight side relative to the second straight side; an insertion step of inserting the second straight side in the bottom side of a first slot and inserting the first straight side in the insertion opening side of a second slot; a connection step of electrically connecting coil ends of a plurality of the coils to each other; and a mounting step of rotatably mounting the rotor inside the stator by means of a bearing.

(7) The present invention discloses the manufacturing method for a rotary electric machine described in (6) above, in which, in the preliminary formation step, the relative rotation is carried out after support jigs are fitted to both end portions of the straight sides of the plurality of element coils in order that they are held to project from both end faces of the stator core.

(8) The present invention discloses the manufacturing method for a rotary electric machine described in (6) above, in which the preliminary formation step is carried out such that the first straight side of each element coil is overlapped over a second straight side of another element coil in the radial direction of the stator core.

(9) The present invention discloses the manufacturing method for a rotary electric machine described in (6) above, in which, in the preforming step, a plurality of circumferentially spaced pairs of the element coils are continuously connected to each other via at least one crossover line.

(10) The present invention discloses the manufacturing method for a rotary electric machine described in (9) above, in which, in the preforming step, the crossover line is provided on only one end side of the stator core.

(11) The present invention discloses the manufacturing method for a rotary electric machine described in (10) above, in which, in the preforming step, a plurality of the crossover lines are extended between the inner and outer peripheries of the stator core in a substantially spiral manner as viewed in the axis direction of the stator core.

(12) The present invention discloses the manufacturing method for a rotary electric machine described in (11) above, in which, in the preforming step, the plurality of the crossover lines are configured to axially project to approximately the same height above the end face of the stator core.

(13) The present invention discloses the manufacturing method for a rotary electric machine described in (6) above, in which, in the positioning step, the second straight side is inserted in the first slot, and in which, in the preliminary formation step, the first straight side is rotated relative to the first slot by an inner jig.

(14) The present invention discloses the manufacturing method for a rotary electric machine described in (13) above, in which, in the preliminary formation step, a tooth support jig is inserted between the bottom of each slot and the straight side of the element coil inserted in the bottom side of the slot.

(15) The present invention discloses the manufacturing method for a rotary electric machine described in (14) above, in which, the inner jig has outer grooves facing the slots one to one and therefore having the same number as that of the slots, where each groove has a pushing member which can be radially projected and retracted from its bottom, and in which the insertion step is performed by pushing out a plurality of the pushing members.

(16) The present invention discloses the manufacturing method for a rotary electric machine described in (6) above, in which, after the insertion step and before the connection step, an insulated support lid is fixed to the insertion opening of each slot.

(17) The present invention discloses the manufacturing method for a rotary electric machine described in (6) above, in which, the preliminary formation step is carried out while pressing both coil ends each connecting opposing straight sides of each element coil against respective axial end faces of the stator core.

(18) The present invention discloses the manufacturing method for a rotary electric machine described in (6) above, in which, the insertion step is carried out while pressing both coil ends each connecting opposing straight sides of each element coil against respective axial end faces of the stator core.

(19) The present invention discloses the manufacturing method for a rotary electric machine described in (6) above, in which, in the preforming step, the element coils of a pair are formed adjacently such that each element coil of the pair can be inserted in two neighboring slots of the stator core.

(20) The present invention discloses the manufacturing method for a rotary electric machine described in (19) above, in which, in the preforming step, to each other are connected innermost turns of each of the element coils of a pair.

(21) The present invention discloses the manufacturing method for a rotary electric machine described in (20) above, in which, in the preforming step, a conductor is formed in a projection-and-depression (meander) shape and then the projecting portions thereof are wound around a shaping jig.

(22) The present invention discloses the manufacturing method for a rotary electric machine described in (6) above, in which, in the preforming step, both coil ends each connecting both straight sides of each element coil are formed in a substantially P-shape, and in which, in the positioning step, each element coil is positioned such that the projecting side of the P-shaped coil ends thereof faces toward the outer periphery side of the stator core.

(23) The present invention discloses the manufacturing method for a rotary electric machine described in (6) above, in which, in the preforming step, both coil ends connecting both straight sides of each element coil are deformed to project in one direction, and in which, in the positioning step, each element coil is positioned such that the projecting side of the deformed coil ends thereof faces toward the outer periphery side of the stator core.

(24) The present invention discloses the manufacturing method for a rotary electric machine described in (6) above, in which, after the preforming step, adjacently wound turns of the element coil are bonded together.

(25) The present invention discloses a manufacturing method for a stator in which the stator comprises: a stator core having a plurality of circumferentially spaced slots each having a coil insertion opening on its inner periphery side; and a coil wound around the stator core through the slots, the manufacturing method including: a preforming step of forming a continuous coil including an ovally wound multi-turn element coil; a positioning step of inserting only a first long side of each oval element coil in a corresponding first slot and arranging a plurality of the oval element coils such that the minor axes thereof are radially oriented to the axis of the stator core; a preliminary formation step of rotating a second long side of each oval element coil relative to the stator core; an insertion step of inserting the second long side of each oval element coil in a corresponding second slot different from the first slot through the coil insertion opening thereof; and a connection step of connecting coil ends of a plurality of the coils to each other.

(26) The present invention discloses a manufacturing method for a rotary electric machine in which the rotary electric machine comprises: a stator including: a stator core having a plurality of circumferentially spaced slots each having a coil insertion opening on its inner periphery side, and a coil wound around the stator core through the slots; and a rotor having a plurality of circumferentially spaced magnetic poles and rotating relative to the stator, the manufacturing method including: a preforming step of forming a continuous coil including a spirally wound multi-turn element coil having a pair of opposing straight sides; a setting step of setting a plurality of the element coils in two slide jigs such that the opposing straight sides of each element coil are parallely fitted into a pair of holding members, which are respectively provided in the two slide jigs and face each other; a preliminary formation step of expanding distance between the opposing straight sides of each element coil by linearly sliding at least one of the slide jigs relative to the other, and thereafter forming a set of a plurality of the continuous coils into a circle in such a manner that one end thereof in sliding direction is laid over the other end; an insertion step of inserting the straight side of the preliminary formed element coils positioned at the outer side of the circle into the bottom side of the slots and inserting the straight side thereof positioned at the inner side of the circle into the insertion opening side of the slots; a connection step of connecting ends of a plurality of the coils to each other on the basis of a required function; and a mounting step of rotatably mounting the rotor inside the stator by means of a bearing.

(27) The present invention discloses the manufacturing method for a rotary electric machine described in (26) above, in which the coil is formed of a flat conductor having a substantially rectangular cross section, and in which, in the preliminary formation step, the holding members of at least one slide jig and the straight sides of the element coils held therein are tilted together after or during the linear sliding operation so that at least one straight side of each element coil is twisted and is oriented in the radial direction when the set of a plurality of the continuous coils are formed into a circle.

(28) The present invention discloses the manufacturing method for a rotary electric machine described in (26) above, in which, in the preliminary formation step, the set of the plurality of the continuous coils is formed into the circle by winding it around an inner jig having a plurality of grooves on its outer periphery.

(29) The present invention discloses the manufacturing method for a rotary electric machine described in (28) above, in which each groove of the inner jig has a pushing member that can be radially projected and retracted from its bottom, and in which the insertion step is performed by pushing out a plurality of the pushing members.

(30) The present invention discloses the manufacturing method for a rotary electric machine described in (29) above, in which, the insertion step is carried out while pressing both coil ends each connecting opposing straight sides of each element coil against respective axial end faces of the stator core.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A manufacturing method for a rotary electric machine, including steps of:
(1) preforming a coil comprising a plurality of element coils of an insulated conductor;
(2) inserting a first side of a first element coil of the element coils into a first slot of a stator core through an opening of the first slot;
(3) inserting a second side of the first element coil into a second slot in which a first side of a second element coil of the element coils has been already inserted;
(4) electrically connecting coil ends of a plurality of the coils to each other; and
(5) rotatably mounting a rotor inside the stator core.

2. The manufacturing method according to claim 1, wherein the step (2) includes steps of:
inserting the first side of the first element coil into the first slot of the stator core from the opening of the first slot; and
placing the second side of the first element coil near the inner periphery of the stator core,
and wherein the step (3) includes the step of inserting the second side of the first element coil placed near the inner periphery of the stator core into the second slot, which is apart from the first slot by a predetermined number of slots and in which the first side of the second element coil has been already inserted.

3. The manufacturing method according to claim 1,
wherein each element coil is wound multiple turns in the step (1),
wherein the step (2) includes steps of:
inserting the first side of the first multi-turn element coil into the first slot of the stator core from the opening of the first slot;
laying, one above another, the multi-turn conductors on the first side of the first multi-turn element coil in the depth direction of the first slot; and
further placing the second side of the first multi-turn element coil near the inner periphery of the stator core,
and wherein the step (3) includes steps of:
inserting the second side of the first multi-turn element coil into the second slot, which is apart from the first slot by the predetermined number of slots and in which the first side of the second multi-turn element coil has been already inserted; and
laying, one above another, the multi-turn conductors on the second side of the first multi-turn element coil in the depth direction of the second slot.

4. The manufacturing method according to claim 1,
wherein the step (1) is carried out by winding each element coil multiple turns of the insulated conductor and by connecting a plurality of the multi-turn element coils by means of a crossover line,
wherein the step (2) includes steps of:
inserting the first side of the first multi-turn element coil into the first slot of the stator core through the opening of the first slot;
laying, one above another, the multi-turn conductors on the first side of the first multi-turn element coil in the depth direction of the first slot;
further placing the second side of the first multi-turn element coil near the inner periphery of the stator core; and
further placing the crossover line on one axial end side of the stator core,
and wherein the step (3) includes steps of:
inserting the second side of the first multi-turn element coil into the second slot, which is apart from the first slot by the predetermined number of slots and in which the first side of the second multi-turn element coil has been already inserted; and
laying, one above another, the multi-turn conductors on the second side of the first multi-turn element coil in the depth direction of the second slot.

5. A manufacturing method for a rotary electric machine in which the rotary electric machine comprises: a stator including: a stator core having a plurality of circumferentially spaced slots each having a coil insertion opening on its inner periphery side, and a coil wound around the stator core through the slots; and a rotor having a plurality of circumferentially spaced magnetic poles and rotating relative to the stator, the manufacturing method including:
a preforming step of forming a continuous coil including a spirally wound multi-turn element coil having a pair of opposing straight sides;
a positioning step of positioning a plurality of the element coils such that opposing first and second straight sides of each element coil are respectively positioned on the inner and outer periphery sides of the stator core;
a preliminary formation step of rotating the first straight side relative to the second straight side;
an insertion step of inserting the second straight side in the bottom side of a first slot and inserting the first straight side in the insertion opening side of a second slot;
a connection step of electrically connecting coil ends of a plurality of the coils to each other; and
a mounting step of rotatably mounting the rotor inside the stator by means of a bearing.

6. The manufacturing method according to claim 5, wherein, in the preliminary formation step, the relative rotation is carried out after support jigs are fitted to both end portions of the straight sides of the plurality of element coils in order that they are held to project from both end faces of the stator core.

7. The manufacturing method according to claim 5, wherein the preliminary formation step is carried out such that the first straight side of each element coil is radially overlapped over a second straight side of another element coil in the radial direction of the stator core.

8. The manufacturing method according to claim 5, wherein, in the preforming step, a plurality of circumferentially spaced pairs of the element coils are continuously connected to each other via at least one crossover line.

9. The manufacturing method according to claim 5,
wherein, in the positioning step, the second straight side is inserted in the first slot; and
wherein, in the preliminary formation step, the first straight side is rotated relative to the first slot by an inner jig.

10. The manufacturing method according to claim 5, wherein, after the insertion step and before the connection step, an insulated support lid is fixed to the insertion opening of each slot.

11. The manufacturing method according to claim 5, wherein, the preliminary formation step is carried out while pressing both coil ends each connecting opposing straight sides of each element coil against respective axial end faces of the stator core.

12. The manufacturing method according to claim 5, wherein, the insertion step is carried out while pressing both coil ends each connecting opposing straight sides of each element coil against respective axial end faces of the stator core.

13. The manufacturing method according to claim 5, wherein, in the preforming step, the element coils of a pair are formed adjacently such that each element coil of the pair can be inserted in two neighboring slots of the stator core.

14. The manufacturing method according to claim 5,
wherein, in the preforming step, both coil ends each connecting both straight sides of each element coil are formed in a substantially P-shape, and
wherein, in the positioning step, each element coil is positioned such that projecting side of the P-shaped coil ends thereof faces toward the outer periphery side of the stator core.

15. The manufacturing method according to claim 5,
wherein, in the preforming step, both coil ends connecting both straight sides of each element coil are deformed to project in one direction, and
wherein, in the positioning step, each element coil is positioned such that projecting side of the deformed coil ends thereof faces toward the outer periphery side of the stator core.

16. The manufacturing method according to claim 5, wherein, after the preforming step, adjacently wound turns of the element coil are bonded together.

17. A manufacturing method for a stator in which the stator comprises: a stator core having a plurality of circumferentially spaced slots each having a coil insertion opening on its inner periphery side; and a coil wound around the stator core through the slots, the manufacturing method including:
a preforming step of forming a continuous coil including an ovally wound multi-turn element coil;
a positioning step of inserting only a first long side of each oval element coil in a corresponding first slot and arranging a plurality of the oval element coils such that the minor axes thereof are radially oriented to an axis of the stator core;
a preliminary formation step of rotating a second long side of each oval element coil relative to the stator core;
an insertion step of inserting the second long side of each oval element coil in a corresponding second slot different from the first slot through the coil insertion opening thereof; and
a connection step of connecting coil ends of a plurality of the coils to each other.

18. A manufacturing method for a rotary electric machine in which the rotary electric machine comprises: a stator including: a stator core having a plurality of circumferentially spaced slots each having a coil insertion opening on its inner periphery side, and a coil wound around the stator core through the slots; and a rotor having a plurality of circumferentially spaced magnetic poles and rotating relative to the stator, the manufacturing method including:
a preforming step of forming a continuous coil including a spirally wound multi-turn element coil having a pair of opposing straight sides;
a setting step of setting a plurality of the element coils in two slide jigs such that the opposing straight sides of each element coil are parallely fitted into a pair of holding members, which are respectively provided in the two slide jigs and face each other;
a preliminary formation step of expanding distance between the opposing straight sides of each element coil by linearly sliding at least one of the slide jigs relative to the other, and thereafter forming a set of a plurality of the continuous coils into a circle in such a manner that one end thereof in sliding direction is laid over the other end;
an insertion step of inserting the straight side of the preliminary formed element coils positioned at outer side of the circle into the bottom side of the slots and inserting the straight side thereof positioned at inner side of the circle into the insertion opening side of the slots;
a connection step of connecting ends of a plurality of the coils to each other on the basis of a required function; and
a mounting step of rotatably mounting the rotor inside the stator by means of a bearing.

19. The manufacturing method according to claim 18,
wherein the coil is formed of a flat conductor having a substantially rectangular cross section, and
wherein, in the preliminary formation step, the holding members of at least one slide jig and the straight sides of the element coils held therein are tilted together after or during the linear sliding operation so that at least one straight side of each element coil is twisted and is oriented in the radial direction when the set of a plurality of the continuous coils are formed into a circle.

20. The manufacturing method according to claim 18, wherein, in the preliminary formation step, the set of the plurality of the continuous coils is formed into the circle by winding it around an inner jig having a plurality of grooves on its outer periphery.
